(19) United States
(12) Patent Application Publication
(10) Pub. No.: US 2016/0132640 A1
(43) Pub. Date: May 12, 2016

(54) SYSTEM, METHOD AND COMPUTER READABLE MEDIUM FOR RAPID DNA IDENTIFICATION

(71) Applicant: UNIVERSITY OF VIRGINIA PATENT FOUNDATION, Charlottesville, VA (US)

(72) Inventors: Ryan LAYER, Salt Lake City, UT (US); Aaron QUINLAN, Salt Lake City, UT (US)

(21) Appl. No.: 14/896,702

(22) PCT Filed: Jun. 10, 2014
(86) PCT No.: PCT/US2014/041695

§ 371 Date: Dec. 8, 2015

Related U.S. Application Data
(60) Provisional application No. 61/833,137, filed on Jun. 10, 2013.

(51) Int. Cl. G06F 19/24; G06N 7/00

(52) U.S. Cl. CPC G06F 19/24; G06N 7/005

(57) ABSTRACT

An extremely efficient method and system for identifying an unknown DNA sample based on probabilistic data structures and machine learning techniques. The method and system can quickly and accurately determine a sample's most likely species, sub-species, or strain. The method and system can identify unknown DNA samples with high accuracy and efficiency (reduced time and resources) without requiring alignment. As such, the method and system is suited to develop innovative applications for, but not limited thereto, many clinical, agricultural, environmental and military/forensic scenarios where the rapid classification of DNA may be of critical utility.

### CROSS-REFERENCE TO RELATED APPLICATIONS

The present application claims benefit of priority under 35 U.S.C. §119(e) from U.S. Provisional Application Ser. No. 61/833,137, filed Jun. 10, 2013, entitled “System, Method and Computer Readable Medium for Rapid DNA Identification;” the disclosure of which is hereby incorporated by reference herein in its entirety.

### STATEMENT OF GOVERNMENT INTEREST

This invention was made with government support under Grant No. R01 HG006693-01, awarded by the National Institutes of Health. The government has certain rights in the invention.

### TECHNICAL FIELD

This invention relates generally to the field of rapid identification and classification of unknown samples. More specifically, the invention is directed towards the method and system for identifying a species, subspecies, and/or strain of an unknown sample for determining or predicting the status of materials, diseases and conditions.

### BACKGROUND

Sequencing the first human genome required a decade of international effort and nearly three billion dollars. In the ten years since its completion, staggering advances have been made and DNA sequencing is now faster, cheaper, and more accurate than ever. Today, a single human genome can be sequenced in 24 hours for about $5,000

Despite the tremendous cost and speed breakthroughs that have been made in DNA sequencing, there have been few complementary breakthroughs in algorithms for rapidly interpreting DNA. A staple of DNA analysis is the alignment and comparison of molecular sequences from an experimental sample to databases containing sequences from thousands of organisms in order to determine the most closely related species or strain. Alignment-based DNA identification techniques explicitly identify similarities between every sequence in the experimental sample and every sequence in the database. To determine which species the sample represents, a consensus must be reached among the most similar database sequences. Existing alignment implementations such as BLAST and FASTA are extremely computationally intensive, and therefore require substantial time and computing resources.

There is a long felt need in the art for low (or reduced) cost approaches of DNA identification, as well as portable systems for accurately identifying DNA without necessarily requiring intensive sequence alignment.

### OVERVIEW

An aspect of an embodiment of the present invention provides, among other things, an extremely efficient algorithm (and method, system and computer readable medium) for identifying an unknown DNA sample based on Bloom filters and machine learning techniques. An aspect of an embodiment of the present invention provides an algorithm, method, system and computer readable medium that, among other things, quickly and accurately determines a sample's most likely species, sub-species, or strain. For instance, an aspect of an embodiment of the present invention provides an algorithm (and method, system and computer readable medium) that does not require sequence alignment and is therefore extremely computationally efficient. Based on the observation that, thanks to evolution, the genomes of diverse species are markedly different, determining whether an unknown sample is more similar to species A or species B does not demand exhaustive sequence alignment. Instead, the comparison merely requires an approach that is sensitive enough to detect the informative differences. An aspect of an embodiment of the present invention provides an algorithm, method, system and computer readable medium that can identify unknown DNA samples with high accuracy and efficiency (time and resources) without alignment. Given the efficiency of the various embodiments of the present invention compared to alternative approaches, an embodiment of the present invention algorithm, method, system and computer readable medium is well-suited to develop innovative applications for, but not limited thereto, many clinical, agricultural, environmental and military/forensic scenarios where the rapid classification of DNA is of critical utility. It should be appreciated that the utility of an embodiment of the present invention algorithm, method, system and computer readable medium only increases as more species genomes are sequenced and as the throughput, economy, and portability of DNA sequencing continues to increase at a staggering rate.

An aspect of an embodiment of the present invention provides, but not limited thereto, a method for identifying a species, subspecies, and/or strain of an unknown sample. The method may comprise: constructing distinct k-mer profiles from genomes of known species, sub-species, and strains; cataloging at least some of the constructed k-mer profiles; training the cataloged k-mer profiles to distinguish from species, subspecies, and/or strain in the catalog versus species subspecies, and/or strain, respectively, that are not in the catalog; receiving genome sequenced information from the unknown sample; and identifying, based on the trained catalog, the type or types of species, subspecies or strain contained within the unknown sample.

An aspect of an embodiment of the present invention provides, but not limited thereto, a method of providing a trained catalog for the purpose of identifying a species, subspecies, or strain of an unknown sample. The method of creating the trained catalog may comprise: constructing distinct k-mer profiles from genomes of known species, sub-species, and strains; selecting at least some of the constructed k-mer profiles to provide an interim catalog; and training the selected k-mer profiles to distinguish from species subspecies, and/or strain in the interim catalog versus species, subspecies, and/or strain, respectively, that are not in the interim catalog to provide the trained catalog, wherein the trained catalog is configured, based on the trained selection, to allow the type or types of species, subspecies or strain to be identified from an unknown sample.

An aspect of an embodiment of the present invention provides, but not limited thereto, a method for identifying a species, subspecies, or strain of an unknown sample. The method may comprise: inputting genome sequenced information from the unknown sample, and identifying the type or types of species, subspecies or strain contained within the unknown sample using a trained catalog. And wherein the trained catalog comprises: a construction of distinct k-mer profiles from genomes of known species, sub-species, and strains; and a collection of at least some of the constructed k-mer profiles, wherein the collection have been trained to distinguish from species, subspecies, and/or strain in the collection versus species, subspecies, and/or strain that are not in the collection.

An aspect of an embodiment of the present invention provides, but not limited thereto, a method for identifying a species, subspecies, or strain of an unknown sample. The method may comprise: receiving genome sequenced information from the unknown sample, and identifying the type or types of species, subspecies or strain contained within the unknown sample using a trained catalog. And wherein the trained catalog comprises: a construction of distinct k-mer profiles from genomes of known species, sub-species, and strains; and a collection of at least some of the constructed k-mer profiles, wherein the collection have been trained to distinguish from species subspecies, and/or strain in the collection versus species subspecies, and/or strain that are not in the collection.

An aspect of an embodiment of the present invention provides, but not limited thereto, a system for identifying a species, subspecies, and/or strain of an unknown sample. The system may comprise: a circuit configured for constructing distinct k-mer profiles from genomes of known species, sub-species, and strains; a circuit configured for cataloging at least some of the constructed k-mer profiles; a circuit configured for training the cataloged k-mer profiles to distinguish from species, subspecies, and/or strain in the catalog versus species subspecies, and/or strain, respectively, that are not in the catalog; a circuit configured for receiving genome sequenced information from the unknown sample; and a circuit configured for identifying, based on the trained catalog, the type or types of species, subspecies or strain contained within the unknown sample.

An aspect of an embodiment of the present invention provides, but not limited thereto, a system of providing a trained catalog for the purpose of identifying a species, subspecies, or strain of an unknown sample. The system may comprise: a circuit configured for constructing distinct k-mer profiles from genomes of known species, sub-species, and strains; a circuit configured for selecting at least some of the constructed k-mer profiles to provide an interim catalog; and a circuit configured for training the selected k-mer profiles to distinguish from species subspecies, and/or strain in the interim catalog versus species, subspecies, and/or strain, respectively, that are not in the interim catalog to provide the trained catalog, wherein the trained catalog is configured, based on the trained selection, to allow the type or types of species, subspecies or strain to be identified from an unknown sample.

An aspect of an embodiment of the present invention provides, but not limited thereto, a system for identifying a species, subspecies, or strain of an unknown sample. The system may comprise: a circuit configured for inputting genome sequenced information from the unknown sample, and a circuit configured for identifying the type or types of species, subspecies or strain contained within the unknown sample using a trained catalog. And the trained catalog comprises: a construction of distinct k-mer profiles from genomes of known species, sub-species, and strains; and a collection of at least some of the constructed k-mer profiles, wherein the collection have been trained to distinguish from species, subspecies, and/or strain in the collection versus species, subspecies, and/or strain that are not in the collection.

An aspect of an embodiment of the present invention provides, but not limited thereto, a system for identifying a species, subspecies, or strain of an unknown sample. The method may comprise: a circuit configured for receiving genome sequenced information from the unknown sample, and a circuit configured for identifying the type or types of species, subspecies or strain contained within the unknown sample using a trained catalog. And the trained catalog comprises: a construction of distinct k-mer profiles from genomes of known species, sub-species, and strains; and a collection of at least some of the constructed k-mer profiles, wherein the collection have been trained to distinguish from species subspecies, and/or strain in the collection versus species subspecies, and/or strain that are not in the collection.

An aspect of an embodiment of the present invention provides, but not limited thereto, a non-transitory machine-readable medium, including instructions, which when executed by a machine, cause the machine to: construct distinct k-mer profiles from genomes of known species, sub-species, and strains; catalog at least some of the constructed k-mer profiles; train the cataloged k-mer profiles to distinguish from species, subspecies, and/or strain in the catalog versus species subspecies, and/or strain, respectively, that are not in the catalog; receive genome sequenced information from the unknown sample, and identify, based on the trained catalog, the type or types of species, subspecies or strain contained within the unknown sample.

An aspect of an embodiment of the present invention provides, but not limited thereto, a non-transitory machine-readable medium, including instructions, which when executed by a machine, cause the machine to: construct distinct k-mer profiles from genomes of known species, sub-species, and strains; select at least some of the constructed k-mer profiles to provide an interim catalog; and train the selected k-mer profiles to distinguish from species subspecies, and/or strain in the interim catalog versus species, subspecies, and/or strain, respectively, that are not in the interim catalog to provide the trained catalog, wherein the trained catalog is configured, based on the trained selection, to allow the type or types of species, subspecies or strain to be identified from an unknown sample.

An aspect of an embodiment of the present invention provides, but not limited thereto, a non-transitory machine-readable medium, including instructions, which when executed by a machine, cause the machine to: input genome sequenced information from the unknown sample, and identify the type or types of species, subspecies or strain contained within the unknown sample using a trained catalog. And wherein the trained catalog comprises: a construction of distinct k-mer profiles from genomes of known species, sub-species, and strains; and a collection of at least some of the constructed k-mer profiles, wherein the collection have been trained to distinguish from species, subspecies, and/or strain in the collection versus species, subspecies, and/or strain that are not in the collection.

An aspect of an embodiment of the present invention provides, but not limited thereto, a non-transitory machine-readable medium, including instructions, which when executed by a machine, cause the machine to: receive genome sequenced information from the unknown sample, and identify the type or types of species, subspecies or strain contained within the unknown sample using a trained catalog. And wherein the trained catalog comprises: a construction of distinct k-mer profiles from genomes of known species, sub-species, and strains; and a collection of at least some of the constructed k-mer profiles, wherein the collection have been trained to distinguish from species subspecies, and/or strain in the collection versus species subspecies, and/or strain that are not in the collection.

An aspect of an embodiment of the present invention provides, but not limited thereto, an extremely efficient method and system for identifying an unknown DNA sample based on probabilistic data structures and machine learning techniques. The method and system can quickly and accurately determine a sample's most likely species, sub-species, or strain. The method and system can identify unknown DNA samples with high accuracy and efficiency (reduced time and resources) without requiring alignment. As such, the method and system is suited to develop innovative applications for, but not limited thereto, many clinical, agricultural, environmental and military/forensic scenarios where the rapid classification of DNA may be of critical utility.

These and other objects, along with advantages and features of various aspects of embodiments of the invention disclosed herein, will be made more apparent from the description, drawings and claims that follow.

### BRIEF DESCRIPTION OF THE DRAWINGS

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIG. 1 illustrates generally a flowchart of an example of a method for identifying a species, subspecies and/or strain of an unknown sample.

FIG. 2 illustrates generally an example of a system for identifying a species, subspecies and/or strain of an unknown sample.

FIG. 3 is a block diagram illustrating an example of a machine upon which one or more aspects of embodiments of the present invention can be implemented.

FIG. 4 schematically provides a high-level workflow of an embodiment of the present invention method for alignment-free DNA identification.

FIG. 5 schematically depicts an example of an embodiment of the present invention of how k-mer profiles reflect the underlying genome sequence.

FIG. 6 schematically depicts an embodiment of the present invention encoding a genome into a Bloom filter.

FIG. 7 schematically depicts an embodiment of the present invention querying a Bloom filter.

FIG. 8 schematically depicts a querying a k-mer catalog.

FIG. 9 schematically depicts a genome signature.

FIG. 10 schematically depicts DNA identification applications integrating an embodiment of the present invention approach with portable computing devices (e.g., cell phones or tablets) and portable, USB-driven DNA sequencing devices.

FIG. 11 schematically provides a high-level functional block diagram of an embodiment of the invention and/or portions of the invention.

FIG. 12A schematically depicts a computing device in which an embodiment of the invention may be implemented. In its most basic configuration, the computing device may include at least one processing unit and memory. Memory may be volatile, non-volatile, or some combination of the two. Additionally, the device may also have other features and/or functionality. For example, the device may also include additional removable and/or non-removable storage including, but not limited to, magnetic or optical disks or tape, as well as writable electrical storage media.

FIG. 12B schematically depicts a network system with an infrastructure or an ad hoc network in which embodiments of the invention may be implemented. In this example, the network system comprises a computer, network connection means, computer terminal, and PDA (e.g., a smartphone) or other handheld device.

FIG. 13 schematically depicts a block diagram for a system or related method of an embodiment of the present invention in whole or in part.

FIG. 14 illustrates a system in which one or more embodiments of the invention can be implemented using a network, or portions of a network or computers.

### DETAILED DESCRIPTION OF EXEMPLARY EMBODIMENTS OF THE INVENTION

An aspect of an embodiment of the present invention DNA classification method, system or computer readable medium is based upon, among other things, the construction and comparison of k-mer profiles that represent the DNA content of a species's genome. The “k-mers” in a genome sequence are essentially the set of all subsequences in a genome of length k. For example, the toy genome sequence ACGTAT is comprised of four distinct k-mers of length 3 (“3-mers”): ACG, CGT, GTA, and TAT. Using this model, we can think of a genome as a set of millions (or billions in the case of the human genome) of DNA k-mers. The evolutionary forces of mutation and selection drive the genome sequences of two species to differ. Therefore, Applicants submit that by extension, the set of k-mers (referred to henceforth as “k-mer profiles”) observed in two distinct species will also differ.

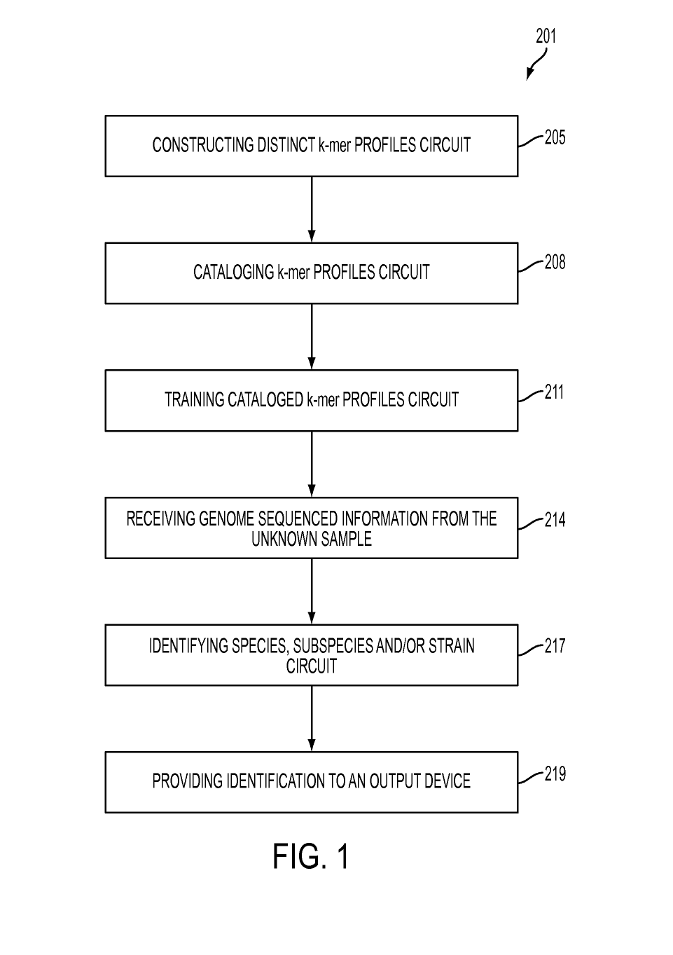

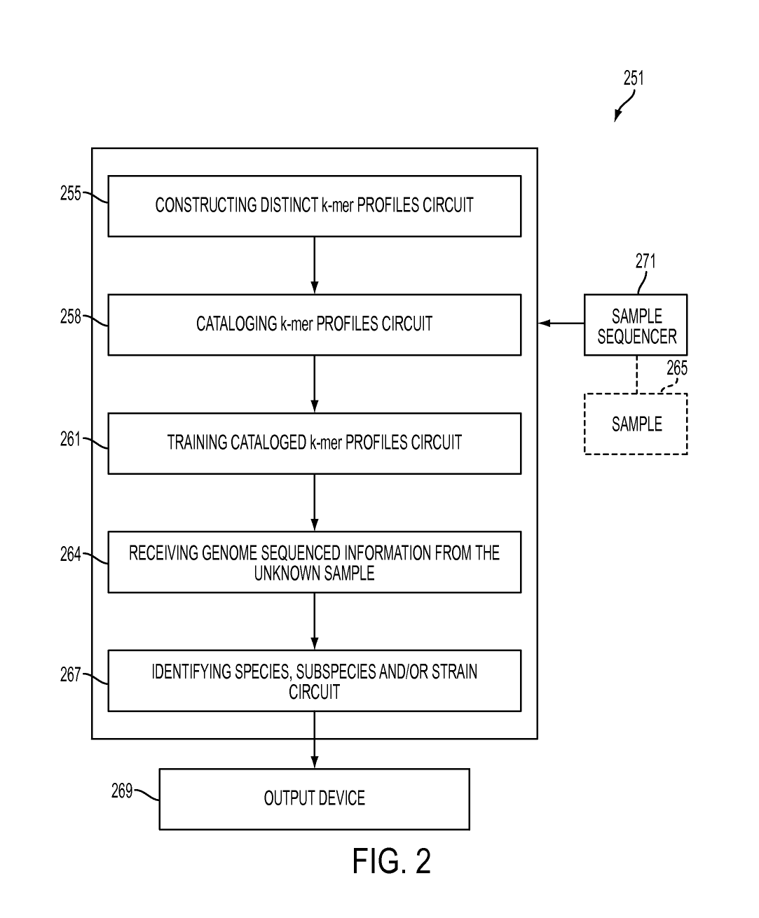

FIG. 1 illustrates generally a flowchart of an example of a method 201 for identifying a species, subspecies and/or strain of an unknown sample. Portions or techniques discussed above in relation to one or more of FIGS. 2-14 can be used to perform various techniques described below. At 205, constructing distinct k-mer profiles from genomes of known species, sub-species, and strains can be implemented. At 208, cataloging at least some of the constructed k-mer profiles can be implemented. At 211, training the cataloged k-mer profiles to distinguish from species, subspecies, and/or strain in the catalog versus species subspecies, and/or strain, respectively, which are not in the catalog can be implemented. At 214, receiving genome sequence information from the unknown sample can be implemented. At 217, identifying, based on the trained catalog, the type or types of species, subspecies or strain contained within the unknown sample can be implemented. At 219, providing identification to an output device can be implemented. An output device may be, for example, storage, memory, network, or display.

Still referring to FIG. 1, the constructing of k-mer profiles may be implemented with a probabilistic data structure. For instance, the probabilistic data structure may be one or more of any combination of the following: set of Bloom Filters, CountMin Sketch, Bitstate Hashing, and Hash Compaction; or other types as desired or required. The catalog may be tailored for a particular application. Such applications may include, but not limited thereto, at least one or more of any combination of the following: prediction of a species of interest, prediction of a specific substrain of interest (e.g., virulent versus non-virulent), detection of contaminated agriculture products, detection of contaminated water, detection of genetically-modified crops, exposure to biowarfare agents, detecting, monitoring, and tracking infection outbreaks, and disease prediction based on DNA circulating in blood or other tissue; as well as others as desired or required. The training may be implemented with a supervised learning algorithm. In an example, the supervised learning algorithm comprises one or more of: machine learning or probabilistic selection; or other types as desired or required.

In an example, the machine learning may include one or more of any combination of the following: Naï ve Bayes Classifier, Neural Networks, Decision Trees, Generalized Linear Models, Nearest Neighbors, Support Vector Machines, or “ensemble” methods such as Random Forests that combine the predictions of multiple supervised machine learning models. Still yet, the training may be accomplished through simulation.

FIG. 2 illustrates generally an example of a system 251 for identifying a species, subspecies and/or strain of an unknown sample 265. The system 251 can optionally include a circuit 255 configured for constructing distinct k-mer profiles from genomes of known species, sub-species, and strains. In an example, the 255 circuit may be communicatively coupled to an optional circuit 258 configured for cataloging at least some of the constructed k-mer profiles. In an example, the 258 circuit may be communicatively coupled to an optional circuit 261 configured for training the cataloged k-mer profiles to distinguish from species, subspecies, and/or strain in the catalog versus species subspecies, and/or strain, respectively, that are not in the catalog. In an example, the 261 circuit may be communicatively coupled to an optional circuit 264 configured for receiving genome sequenced information from the unknown sample 264. In an example, the circuit 264 may be communicatively coupled to an optional circuit 267 configured for identifying, based on the trained catalog, the type or types of species, subspecies or strain contained within the unknown sample. In an example, the system 251 may be communicatively coupled to an output device 269 that may optionally be, for example, one or more of any combination of the following: storage, memory, network, or display. Moreover, the system may include a genome sequencer device configured sequencing information from the unknown sample 265 to provide sequenced information. The sequencer device may be stationary or portable, or a combination of stationary and portable.

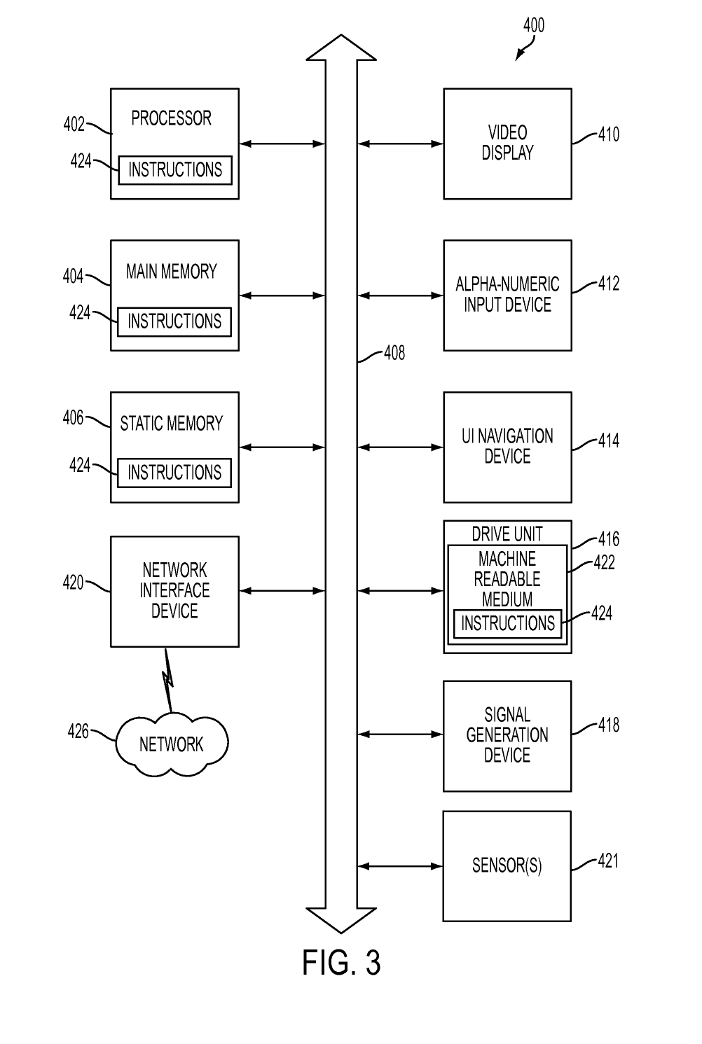

FIG. 3 illustrates a block diagram of an example machine 400 upon which one or more embodiments (e.g., discussed methodologies) can be implemented (e.g., run). Examples of machine 400 can include logic, one or more components, circuits (e.g., modules), or mechanisms. Circuits are tangible entities configured to perform certain operations. In an example, circuits can be arranged (e.g., internally or with respect to external entities such as other circuits) in a specified manner. In an example, one or more computer systems (e.g., a standalone, client or server computer system) or one or more hardware processors (processors) can be configured by software (e.g., instructions, an application portion, or an application) as a circuit that operates to perform certain operations as described herein. In an example, the software can reside (1) on a non-transitory machine readable medium or (2) in a transmission signal. In an example, the software, when executed by the underlying hardware of the circuit, causes the circuit to perform the certain operations.

In an example, a circuit can be implemented mechanically or electronically. For example, a circuit can comprise dedicated circuitry or logic that is specifically configured to perform one or more techniques such as discussed above, such as including a special-purpose processor, a field programmable gate array (FPGA) or an application-specific integrated circuit (ASIC). In an example, a circuit can comprise programmable logic (e.g., circuitry, as encompassed within a general-purpose processor or other programmable processor) that can be temporarily configured (e.g., by software) to perform the certain operations. It will be appreciated that the decision to implement a circuit mechanically (e.g., in dedicated and permanently configured circuitry), or in temporarily configured circuitry (e.g., configured by software) can be driven by cost and time considerations.

Accordingly, the term “circuit” is understood to encompass a tangible entity, be that an entity that is physically constructed, permanently configured (e.g., hardwired), or temporarily (e.g., transitorily) configured (e.g., programmed) to operate in a specified manner or to perform specified operations. In an example, given a plurality of temporarily configured circuits, each of the circuits need not be configured or instantiated at any one instance in time. For example, where the circuits comprise a general-purpose processor configured via software, the general-purpose processor can be configured as respective different circuits at different times. Software can accordingly configure a processor, for example, to constitute a particular circuit at one instance of time and to constitute a different circuit at a different instance of time.

In an example, circuits can provide information to, and receive information from, other circuits. In this example, the circuits can be regarded as being communicatively coupled to one or more other circuits. Where multiple of such circuits exist contemporaneously, communications can be achieved through signal transmission (e.g., over appropriate circuits and buses) that connect the circuits. In embodiments in which multiple circuits are configured or instantiated at different times, communications between such circuits can be achieved, for example, through the storage and retrieval of information in memory structures to which the multiple circuits have access. For example, one circuit can perform an operation and store the output of that operation in a memory device to which it is communicatively coupled. A further circuit can then, at a later time, access the memory device to retrieve and process the stored output. In an example, circuits can be configured to initiate or receive communications with input or output devices and can operate on a resource (e.g., a collection of information).

The various operations of method examples described herein can be performed, at least partially, by one or more processors that are temporarily configured (e.g., by software) or permanently configured to perform the relevant operations. Whether temporarily or permanently configured, such processors can constitute processor-implemented circuits that operate to perform one or more operations or functions. In an example, the circuits referred to herein can comprise processor-implemented circuits.

Similarly, the methods described herein can be at least partially processor-implemented. For example, at least some of the operations of a method can be performed by one or processors or processor-implemented circuits. The performance of certain of the operations can be distributed among the one or more processors, not only residing within a single machine, but deployed across a number of machines. In an example, the processor or processors can be located in a single location (e.g., within a home environment, an office environment or as a server farm), while in other examples the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., Application Program Interfaces (APIs).)

Example embodiments (e.g., apparatus, systems, or methods) can be implemented in digital electronic circuitry, in computer hardware, in firmware, in software, or in any combination thereof. Example embodiments can be implemented using a computer program product (e.g., a computer program, tangibly embodied in an information carrier or in a machine readable medium, for execution by, or to control the operation of, data processing apparatus such as a programmable processor, a computer, or multiple computers).

A computer program can be written in any form of programming language, including compiled or interpreted languages, and it can be deployed in any form, including as a stand-alone program or as a software module, subroutine, or other unit suitable for use in a computing environment. A computer program can be deployed to be executed on one computer or on multiple computers at one site or distributed across multiple sites and interconnected by a communication network.

In an example, operations can be performed by one or more programmable processors executing a computer program to perform functions by operating on input data and generating output. Examples of method operations can also be performed by, and example apparatus can be implemented as, special purpose logic circuitry (e.g., a field programmable gate array (FPGA) or an application-specific integrated circuit (ASIC)).

The computing system can include clients and servers. A client and server are generally remote from each other and generally interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine 400) and software architectures that can be deployed in example embodiments.

In an example, the machine 400 can operate as a standalone device or the machine 400 can be connected (e.g., networked) to other machines.

In a networked deployment, the machine 400 can operate in the capacity of either a server or a client machine in server-client network environments. In an example, machine 400 can act as a peer machine in peer-to-peer (or other distributed) network environments. The machine 400 can be a personal computer (PC), a tablet PC, a set-top box (STB), a Personal Digital Assistant (PDA), a mobile telephone, a web appliance, a network router, switch or bridge, or any machine capable of executing instructions (sequential or otherwise) specifying actions to be taken (e.g., performed) by the machine 400. Further, while only a single machine 400 is illustrated, the term “machine” shall also be taken to include any collection of machines that individually or jointly execute a set (or multiple sets) of instructions to perform any one or more of the methodologies discussed herein.

Example machine (e.g., computer system) 400 can include a processor 402 (e.g., a central processing unit (CPU), a graphics processing unit (GPU) or both), a main memory 404 and a static memory 406, some or all of which can communicate with each other via a bus 408. The machine 400 can further include a display unit 410, an alphanumeric input device 412 (e.g., a keyboard), and a user interface (UI) navigation device 411 (e.g., a mouse). In an example, the display unit 810, input device 417 and UI navigation device 414 can be a touch screen display. The machine 400 can additionally include a storage device (e.g., drive unit) 416, a signal generation device 418 (e.g., a speaker), a network interface device 420, and one or more sensors 421, such as a global positioning system (GPS) sensor, compass, accelerometer, or other sensor.

The storage device 416 can include a machine readable medium 422 on which is stored one or more sets of data structures or instructions 424 (e.g., software) embodying or utilized by any one or more of the methodologies or functions described herein. The instructions 424 can also reside, completely or at least partially, within the main memory 404, within static memory 406, or within the processor 402 during execution thereof by the machine 400. In an example, one or any combination of the processor 402, the main memory 404, the static memory 406, or the storage device 416 can constitute machine readable media.

While the machine readable medium 422 is illustrated as a single medium, the term “machine readable medium” can include a single medium or multiple media (e.g., a centralized or distributed database, and/or associated caches and servers) that configured to store the one or more instructions 424. The term “machine readable medium” can also be taken to include any tangible medium that is capable of storing, encoding, or carrying instructions for execution by the machine and that cause the machine to perform any one or more of the methodologies of the present disclosure or that is capable of storing, encoding or carrying data structures utilized by or associated with such instructions. The term “machine readable medium” can accordingly be taken to include, but not be limited to, solid-state memories, and optical and magnetic media. Specific examples of machine readable media can include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 424 can further be transmitted or received over a communications network 426 using a transmission medium via the network interface device 420 utilizing any one of a number of transfer protocols (e.g., frame relay, IP, TCP, UDP, HTTP, etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., IEEE 802.16 standards family known as Wi-Fi®, IEEE 802.16 standards family known as WiMax®), peer-to-peer (P2P) networks, among others. The term “transmission medium” shall be taken to include any intangible medium that is capable of storing, encoding or carrying instructions for execution by the machine, and includes digital or analog communications signals or other intangible medium to facilitate communication of such software.

FIG. 4 schematically provides a high-level workflow of an embodiment of the present invention method for alignment-free DNA identification. In general terms, which are outlined in FIG. 4, an aspect of an embodiment of the present invention method (and related system), may proceed as follows:
1 Construct distinct k-mer profiles 306 from the genomes 304 of all species, sub-species, and strains (e.g. virulent v. benign strains of E. coli) that one wishes to be able to classify based on the specific application.
2 Create a “catalog” 310 of kmer profiles from the species that one wishes to detect.
3 Leverage machine learning algorithms (for example, an embodiment of the present method may use Naive Bayes classifiers, although it should be appreciated that other supervised learning algorithms may be used as desired or required) to train the catalog to distinguish k-mer profiles from the same species versus k-mer profiles samples representing different species. It should be appreciated that other types of probabilistic classifiers may be used.
4 Utilize the knowledge gained from training the catalog to rapidly classify an unknown DNA sample.
   Creating k-mer Profiles of a Given Species Using Bloom Filters.

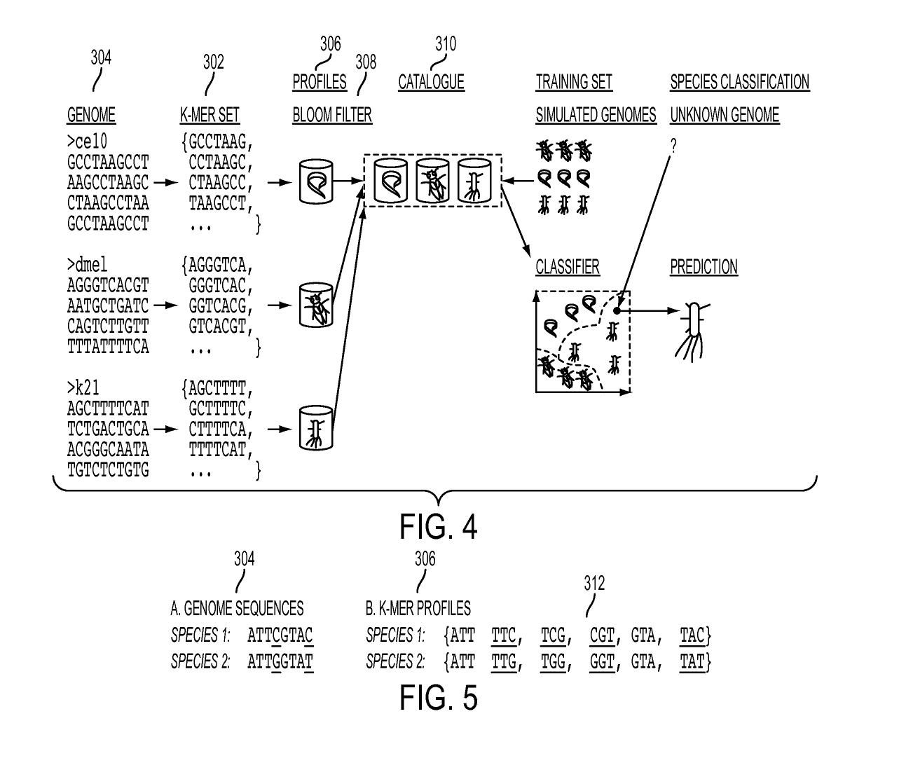

Next, the present inventors discuss creating k-mer profiles of a given species using Bloom filters 308 (although it should be appreciated that other types of probabilistic data structure may be used as desired or required). In an aspect of an embodiment, the method may include creating a k-mer profile 306 of a species's genome 304 by scanning its genomesequence and cataloging each distinct subsequence of length k. A guiding principle behind constructing k-mer profiles is that they directly reflect the DNA content of the species's genome. Thus, if the genomes of two species differ, so will their k-mer profiles. FIG. 5 schematically depicts an example of an embodiment of the present invention of how k-mer profiles reflect the underlying genome sequence. For example, let us consider the genome sequences of two imaginary, yet closely related species (1 and 2) whose genomes differ at two underlined sites (see FIG. 5). The resulting k-mer profiles 306 (where k=3) contain a subset of k-mers 312 that, like the full sequences, distinguishes the genomes of the two example species (as indicated by underlined portions). In addition, the profiles contain k-mers that are common to both species. Because DNA consists of only four nucleotides (A, C, G, T), k-mer profiles with k=1 will clearly be uninformative, since A, C, G, and T will exist in every species yielding no distinguishing features. However, due to evolution, genome sequences are non-random, and as such, the present inventors see many k-mers that are found in only certain species, genuses, or families. Therefore, k-mer profiles with a reasonable size k (empirically, k>=12), contain k-mers that distinguish species, genuses, or strains, thus yielding an efficient means for classifying unknown DNA samples.

Considering the similarity of two k-mer profiles is directly related to the similarity of the two underlying genomes, the relationship between two genomes can be determined by comparing their k-mer profiles. However, a direct comparison of two k-mer profiles requires the storage of every single k-mer found in a given species's genome. This is intractable given the memory requirement for an organism's full k-mer set is an order of magnitude larger than its genome. For example, the E. Coli genome is about 4.5 megabases and has a memory footprint of about 4.5 megabytes. If we choose k=12, there are 4,639,664 k-mers which have a memory footprint of 58 megabytes.

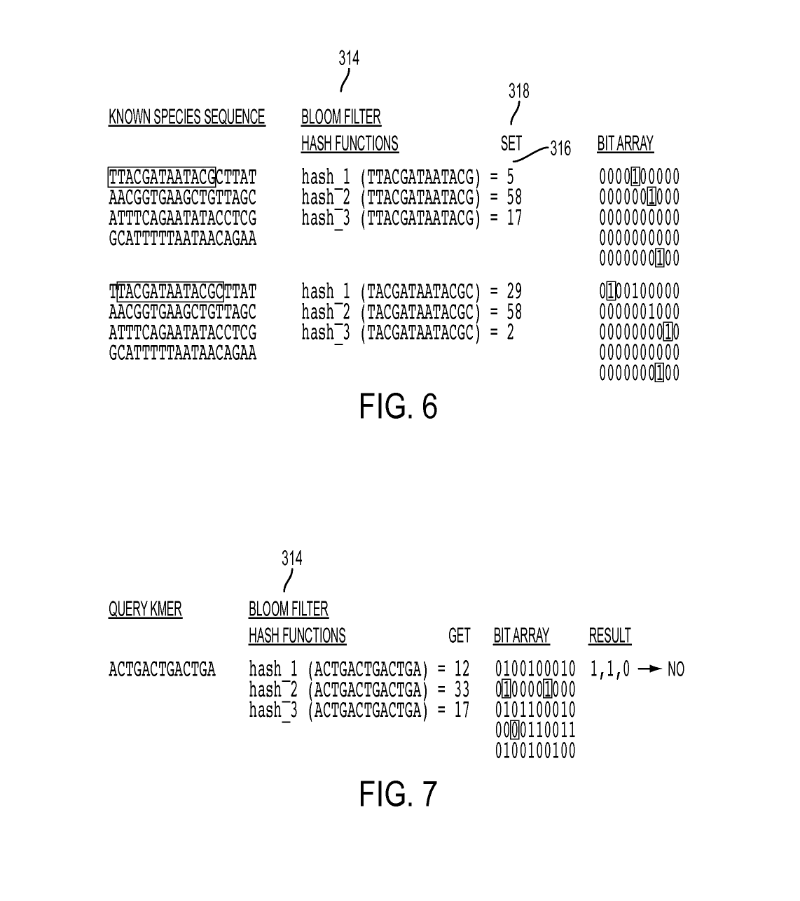

To solve this issue, an aspect of an embodiment of the present invention method, system, or computer readable medium encodes k-mer profiles using a Bloom filter [2], which is a very efficient, probabilistic data structure used to determine if an element is a member of a set. FIG. 6 schematically depicts an embodiment of the present invention encoding a genome into a Bloom filter. A Bloom filter starts as a large array of zeros. Elements are placed into the Bloom filter by marking the positions in the array that correspond to the hash values 314 of the element (see FIG. 6). FIG. 7 schematically depicts an embodiment of the present invention querying a Bloom filter. The existence of an element is tested by checking all of the array positions 316 of that elements hash values (FIG. 7). Instead of directly comparing the k-mers in two sets, an embodiment of the present invention method encodes one set using a Bloom filter and then test for the existence of each k-mer in the other set. The result is a count of k-mers that are common to both sets 318. Closely related genomes will have higher counts than distantly related genomes. It should be appreciated that other types of space-efficient probabilistic data structures (instead of or in addition to Bloom filters) may be utilized as desired or required.

Bloom filters have, but not limited thereto, two fundamental advantages for storing k-mer profiles: first, they have no false negatives: that is, if a k-mer is in a given genome sequence, the Bloom filter will never miss its presence; second, they use very little storage space to represent the full set of k-mers present in a genome (<10 megabytes for the E. coli genome using a simple, “off the shelf” Bloom filter implementation). A possible downside of Bloom filters is that they can produce false positives: that is, they sometimes report that a k-mer is present in a k-mer profile when, in fact, it is not. While seemingly problematic, an upside of Bloom filters is that they are designed such that we can force the false positive rate to be very low and thus achieve high DNA classification accuracy using k-mer profiles without requiring prohibitive amounts of disk storage or RAM.

Training “Catalogs” of k-mer Profiles.

Next, the present inventors discuss training catalogs of k-mer profiles. An aspect of an embodiment of the present invention method may use Bloom filters to create a space-efficient k-mer profile of a genome sequence for a single species. However, the more common use case requires the ability to compare the k-mers in an unknown sample to the k-mer profiles of multiple species that one is interested in detecting. For example, in a hospital setting, we would want the ability to swab a patient's infection, sequence the DNA and rapidly determine whether the DNA from the swab matches a species among a set of pathogens that are especially pernicious in a clinical setting (e.g., Klebsiella, Staphylococcus, Pseudomonas).

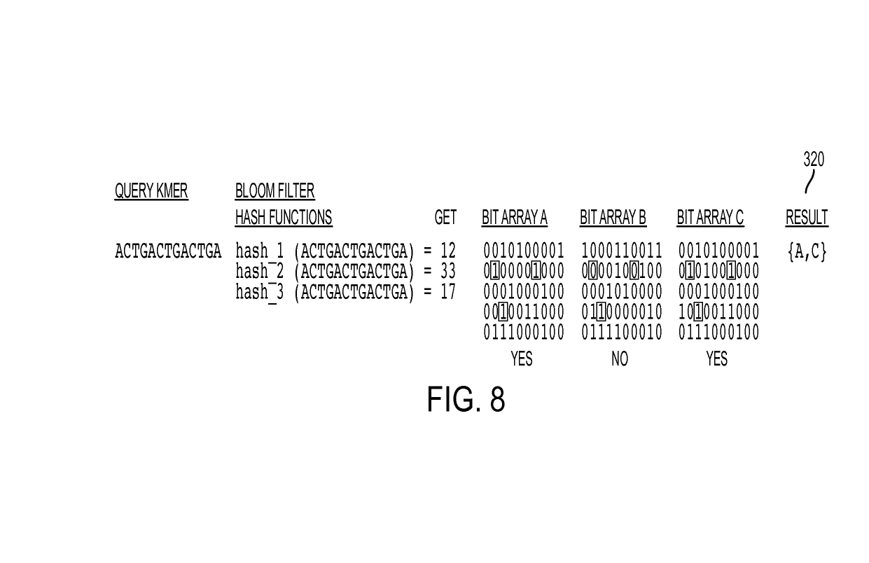

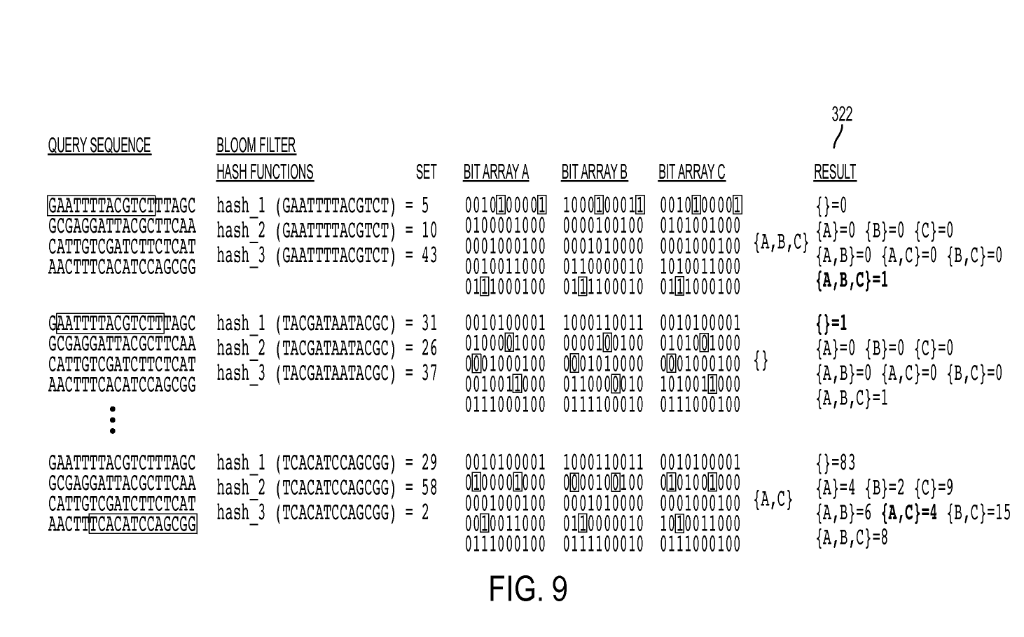

To accomplish this, an aspect of an embodiment of the present invention method may build “catalogs” that include k-mer profiles from all species that we wish to be able to predict for a given application of our algorithm. Each k-mer in the query genome is tested against all of the k-mer profiles in the catalogue, and the result 320 is the subset of profiles that contain that k-mer (See FIG. 8). FIG. 8 schematically depicts a querying a k-mer catalog. The result 322 of testing all k-mers in the query sample is a tally of all matching subsets; we treat this as the signature for the query sample (see FIG. 9). FIG. 9 schematically depicts a genome signature. An aspect of an embodiment of the present invention method is that it then may train the catalog to classify an unknown DNA sample by its signature using a machine learning techniques, such as a Naive Bayes classifier. Training a supervised machine learning technique to classify a DNA sample based on sets of Bloom filter k-mer profiles from multiple species is a unique innovation of an aspect of an embodiment of the present invention method. It should be appreciated that many different supervised machine learning techniques may be used and employed within the context of various approaches of the present invention. For example, in an embodiment of the present invention we have implemented our DNA classification approach using a Naive Bayes classifier, which, like other machine learning strategies, may be trained as follows:
1 Simulate sequencing data for each species in the catalog (e.g., Klebsiella, Staphylococcus, Pseudomonas) using a spectrum of sequencing error rates that mimic those of current and (the expected rates of) forthcoming technologies (0.5%-10%). Also, simulate typical mutation rates among multiple strains of the same species. As such, the simulated sequencing data emulates the sequencing data we would expect to see if the same species were provided as an unknown sample for classification.
2 The k-mers from the simulated sequence data for each species are then compared to each k-mer profile for the species in the catalog. Were there neither sequencing errors nor mutations in the sample genomes, we would expect nearly all of the k-mers (assuming a reasonable size for k such as k>=12) to match the k-mer profile for the simulated species. However, sequencing errors and mutations cause many more k-mers to match not only the k-mer profile of the correct genome, but also the k-mer profiles of other genomes. Even so, it turns out that the patterns of k-mer profile matching are substantially different depending on which genome in the catalog is simulated. This may be a crucial observation that underlies the accuracy and innovation of an aspect of an embodiment of the present invention method: sequencing errors and DNA mutation lead to specific patterns in the way k-mers from one species match the k-mer profiles of the species in the catalog. An aspect of an embodiment of the present invention simulation approach allows the Naive Bayes classifier to “learn” these patterns.

It should be appreciated that other types of probabilistic classifiers (instead of or in addition to Naive Bayes Classifier) may be utilized as desired or required.

Classification of DNA from an Unknown Sample

Next, the present inventors discuss classification of DNA from an unknown sample. Once a catalog of k-mer profiles have been trained as described above, an aspect of an embodiment of the present invention Naive Bayes classification approach (or other supervised learning algorithm) can subsequently determine which k-mer profile the k-mers from an unknown sample are most similar. The Naive Bayes classifier produces a posterior probability reflecting the confidence in its prediction based on the trained catalog.

In summary, the combination of Bloom filters (or other probabilistic data structure) for constructing efficient k-mer profiles of a genome with a machine learning approach that learns to distinguish the k-mer matching patterns of one species versus another while accounting for high sequencing error and genome mutation rates is an entirely novel and non-obvious technique and system. It should be noted that the present inventors have developed a software prototype demonstrating the accuracy and utility of an aspect of an embodiment of the present invention approach.

Accordingly, it should be appreciated that an aspect of an embodiment of the present invention approach is fundamentally superior to alternative approaches for, but not limited thereto, two primary reasons: 1) classifying unknown DNA is extremely fast because the various embodiments of the present invention may make decisions based on k-mer profiles rather than laborious sequence alignment, and 2) the trained catalogs of the various embodiments of the present invention created for classification require very little storage space. Therefore, unlike alternative, alignment-based approaches, an aspect of an embodiment of the present invention algorithm, method, system, and computer readable medium is amenable to a wide range of computing platforms ranging from laptops to mobile devices. As such, broad range of commercial applications that are outlined below may be employed within the context of the invention.

It should be appreciated that unlike existing heuristic approaches for classifying unknown DNA samples, an aspect of an embodiment of the present invention method, system, and computer readable medium is that it can efficiently and accurately classify DNA without the requiring laborious sequence alignment. As we discuss in more detail below regarding some of the “Commercial Applications,” rapid classification of unknown DNA samples enables a wide range of applications ranging where quick turn-around time and minimal computational analysis requirements are vital. Such applications may include, but not limited thereto, the following: clinical settings (e.g., “what is this patient infected with? is it antibiotic-resistant? should we quarantine the patient?”), agricultural settings (e.g., daily testing of crops and/or meat products for E. coli contamination), and forensic and military scenarios (e.g., what is the ethnicity of the individual from which this blood sample came?, and are any of a set of particularly pernicious pathogens or bio-warfare agents present in this DNA sample?). Moreover, extant “state of the art” solutions incur a substantial computational burden, unlike the various embodiments of the present invention method, system, and computer readable medium. As such, heretofore, there are no existing methods that produce a likelihood that the predicted identity of the DNA sample is correct.

An aspect of an embodiment of the present invention method provides, among other things, three unique techniques and observations. First, the k-mer profiles preserve the inherent differences in the genome sequences of different species and are thus a rational approach for characterizing DNA samples without sequence alignment. Second, a probabilistic data structure is employed known as a Bloom filter to efficiently represent k-mer profiles different species's genomes. Third, a novel strategy of the present invention has been developed that leverages machine learning techniques (Naive Bayes classifiers or the like) and sets of Bloom filter profiles (or the like) to predict the identify of an unknown DNA sample.

It should be appreciated that the various an embodiment of the present invention algorithm, method, system and computer readable medium may include a variety of applications for DNA classification strategy. The efficiency and minimal computational demands of the various embodiments of the present invention approach enable several commercial applications owing to the improvements in speed and portability that the present invention method provides. However, it is important to emphasize that the utility of the algorithm, method, system, and computer readable medium is based upon the creation and training of “k-mer profile catalogs” that are customized to specific DNA classification applications. Each catalog for custom application may be developed and trained and continued improvements to the training and classification algorithms will yield new releases of the catalogs and underlying algorithms—all considered part of the present invention and may be employed within the context of the invention.

### Clinical Infection Outbreak Monitoring

Human pathogens have an amazing ability to rapidly evolve when subjected to selective pressure from environmental stress or antibiotics. The widespread (over) use of antibiotics and a decline in the development of new drugs has spawned pernicious strains of drug-resistant pathogens such as tuberculosis and Staphylococcus (e.g., MRSA). In fact, Britain's Chief Medical Officer recently testified that antibiotic resistance poses a global, apocalyptic threat. Pathogens surviving in a hospital setting are the most lethal as they acquire the greatest resistance to a broad spectrum of antibiotics.

According, the real-time methods of the various proposed embodiments of the present invention offer a superior, highly-desirable system for quickly monitoring and controlling pathogen infection in clinical settings. In fact, a recent study tracking a devastating Klebsiella pneumoniae outbreak stated “ . . . our results demonstrate the importance of having ongoing, effective surveillance protocols in place before outbreaks occur” [Snitkin et al.]. When combined with modern DNA sequencing technologies, the various embodiments of the present invention algorithm, method, system and computer readable medium would enable rapid monitoring and classification of patient infections. Moreover, unlike existing approaches that require bacteria to be cultured prior to sequencing, the various embodiments of the present invention algorithm, method, system and computer readable medium have the potential to classify samples without the need for culturing. As such, it should be appreciated that there will be broad clinical utility for the approach of the various embodiments of the present invention; especially as the economy and portability of DNA sequencing technologies continues to improve.

### Agricultural Quality Control

The contamination of agricultural products such as fruits, vegetables, and meat/dairy products with harmful pathogens is a fundamental concern for human health. There have been several notable E. coli contamination events in the last decade that have caused widespread illness, death, and substantial economic consequences.

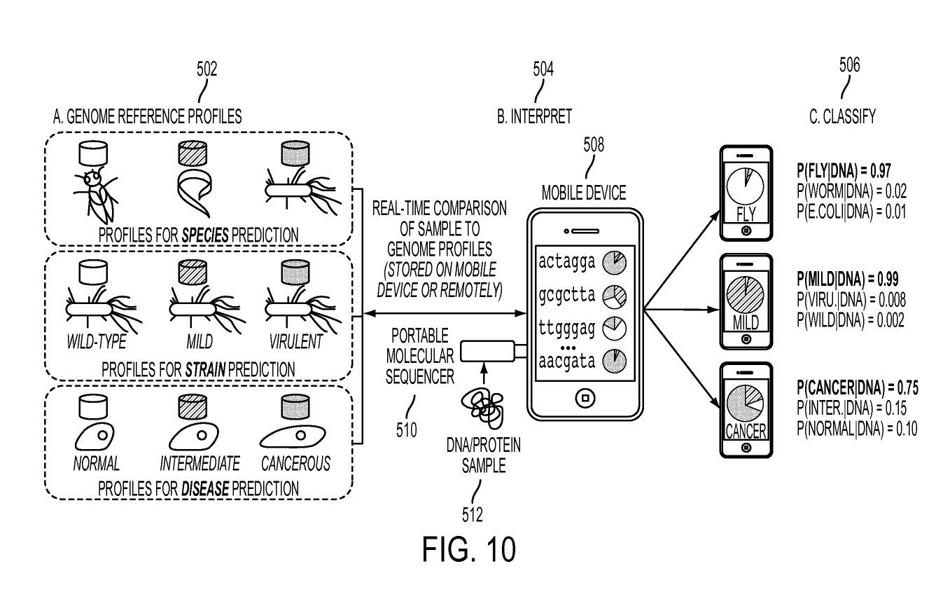

In much the same way as discussed above whereby the various embodiments of the present invention algorithm, method, system and computer readable medium can be used to monitor patient infections (above), it should be appreciated that the same technology and approach can be used to create a simple and efficient system that screens for the contamination of agricultural products with food-borne pathogens. Given the minimal computational demands of the various embodiments of the present invention approach and the imminent availability of portable DNA sequencing technologies (some will even fit on a USB drive), it should be appreciated that the various embodiments of the present invention may be implemented with of portable DNA classification software, processors and systems that can run on a portable device such as a smartphone (see FIG. 10) or other processors as desired, needed or required. FIG. 10 schematically depicts DNA identification applications integrating an embodiment of the present invention approach with portable computing devices (e.g., cell phones or tablets) and portable, USB-driven DNA sequencing devices. FIG. 10 provides, for example, catalogs 502 of three types directed toward species prediction, strain prediction, and disease prediction. The sample 512 may be sequenced through a sequencer such as a molecular sequencer 510 that may be stationary or portable, or any combination thereof. As shown, the sequencer 510 is provided on a USB drive. The sequencer 510 is communicatively coupled to a mobile device 508. The mobile device 508 may be communicatively coupled to the catalog 502, and is configured to carry out at least in part the techniques, methods, and algorithms disclosed herein to identify a species, subspecies, or strain of an unknown sample 512. As generally illustrated, the methods, techniques and algorithms disclosed herein may provide for rapid interpretation 504 and classification 506 as displayed accordingly, for example, so as to include, but not limited thereto, the following: fly DNA species, mild strain of a disease, and cancerous disease.

### Affordable Devices for Detecting Water Contamination

There is an urgent worldwide need for simple, affordable methods for monitoring whether water is potable. This need is especially acute in third-world countries that have spawned research competitions from the Bill and Melinda Gates foundation, the WHO, and other non-profit organizations. It should be appreciated that a customized version of various embodiments of the present invention algorithm, method, system and computer readable medium designed to rapidly detect the handful (see<10; http://water.epa.gov/drink/contaminants/basicinformation/pathogens.cfm, of which is hereby incorporated by reference) of pathogens that are extremely harmful to human health. Accordingly, various embodiments of the present invention algorithm, method, system and computer readable medium provide, among other things, affordable devices for monitoring water quality or other fluids or substances as desired, needed or required.

### Clinical and Research Utility

Additionally, the various embodiments of the present invention algorithm, method, system and computer readable medium also have broad clinical utility, especially for personalized medicine. For example, consumer devices for cancer and recurrence detection that compare DNA from periodic blood samples both to a personal baseline genome sequence (ascertained at birth or childhood) and to a database of known cancer mutations and genes. Furthermore, the mutations underlying an individual's cancer yield patient-specific mutation (and thus k-mer) signatures and serve as a sensitive means of detecting the recurrence of a patient's unique cancer profile. Conceptually similar assays would permit accurate donor matching for urgent organ transplants in both military and emergent trauma situations. In such settings, it should be appreciated that the various embodiments of the present invention algorithm, method, system and computer readable medium shall be implemented in a manner whereby a patient's DNA would be screened against a compact database of genetic markers from the human leukocyte antigen (HLA) and similar regions that govern human immune response.

### Ecological and Metagenomic Surveys

Further yet, another application of the various embodiments of the present invention algorithm, method, system and computer readable medium is the rapid prediction of an unknown sample's species or a best approximation of closely related species or genus. In ecological or metagenomic surveys, however, samples typically contain DNA or protein from many thousands of species. Extensions of the versatile approaches of various embodiments of the present invention algorithm, method, system and computer readable medium shall include the capability to estimate the relative abundance of each species or genus by integrating tracking the presence of each sample k-mer among a set of reference k-mer catalogs from hundreds of relevant species or genera.

### Forensic Applications

Still further yet, careful selection of a relatively small number (ca. 10000) of informative sites in the human genome is also sufficient for determining an anonymous human's ancestry with surprising precision. It should be appreciated that an aspect of various embodiments of the present invention algorithm, method, system and computer readable medium shall include improved machine learning techniques (e.g., multi-class support vector machines) that leverage such ancestry informative markers to yield rapid yet accurate forensic methods for both criminal and military settings, thereby enabling a wide-spectrum of police and military devices.

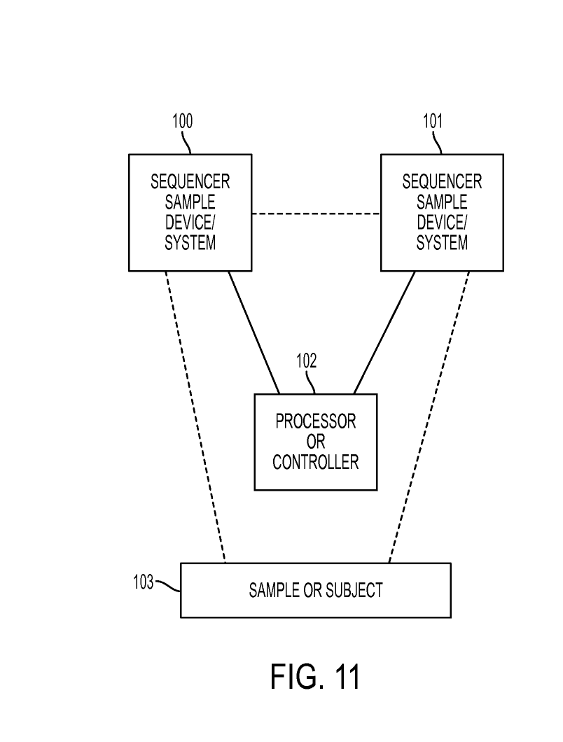

FIG. 11 is a high-level functional block diagram of an embodiment of the invention and/or portions of the invention. As shown in FIG. 11, a processor or controller 102 may communicate with a first sequencer sample device or system 101, and optionally a second sequencer sample device or system 100 (or a plurality of additional sample devices). The sequencer device or system (such as a molecular sequencer) may be any combination of a portable or stationary device or system. In an embodiment, the sequencer device may be as portable as being hand held and may also be on a USB device, for example. The first sequencer sample device 101 communicates with the sample or subject 103 to acquire the information of the sample or subject 103. The sequencer sample device or system may be, for example, a nucleic acid sequencing device/system or protein sequencing device/system. The sequencer sample device/system may generate sequencing data information using known techniques or other future available techniques. The processor or controller 102 is configured to perform the method, steps or calculations of an aspect of an embodiment of the present invention. Optionally, the second sequencer sample device or system 100 communicates with the sample or subject 103 to acquire the information from the sample or subject 103. Again, there may be more than two sequencer sample devices. The sequencer sample devices or systems may be local or remote or any combination thereof. The sequencer sample devices or systems may be portable or stationary or any combination thereof. The first sequencer sample device or system 101 and the second sequencer sample device or system 100 may be implemented as a separate device, system or module or as a single device, system, or module. The processor 102 can be implemented locally in the first sequencer sample device 101, the second sequencer sample device 100, or a standalone device, system or module (or in any combination of two or more of the devices). The processor 102 or a portion of the system can be located remotely such that the sequencing sample device is operated as a telemetry device or system (e.g., telemedicine device). Accordingly, it should be appreciated that the rapid classification approach of an embodiment of the present invention may occur in a device (e.g., processor) located out in the work field or the data may be transmitted to at a remote location, such as to a classification server or the like—or any combination of the two.

A test sample may be obtained from a general sample (e.g., substance or material) or a subject by numerous available means such as by using a needle, swab, pipette, substrate, microchannel, conduit, channel, lab-on-chip device, or needle, as well as any other available means for obtaining biological test samples from a sample or subject.

It should be appreciated that any of the components or modules referred to with regards to any of the present invention embodiments discussed herein, may be integrally or separately formed with one another. Further, redundant functions or structures of the components or modules may be implemented.

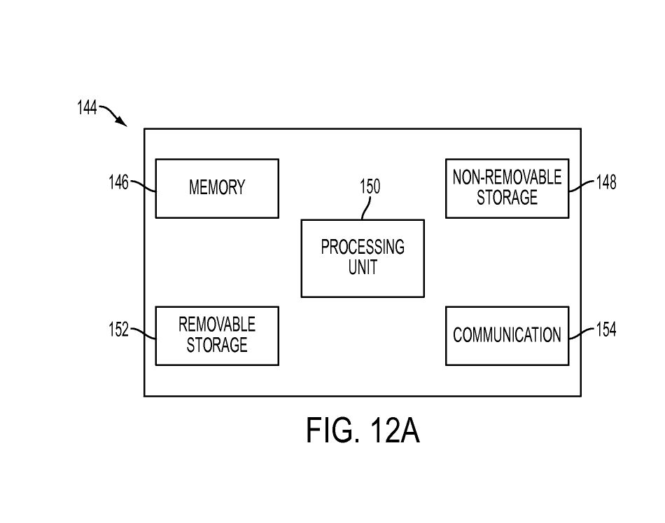

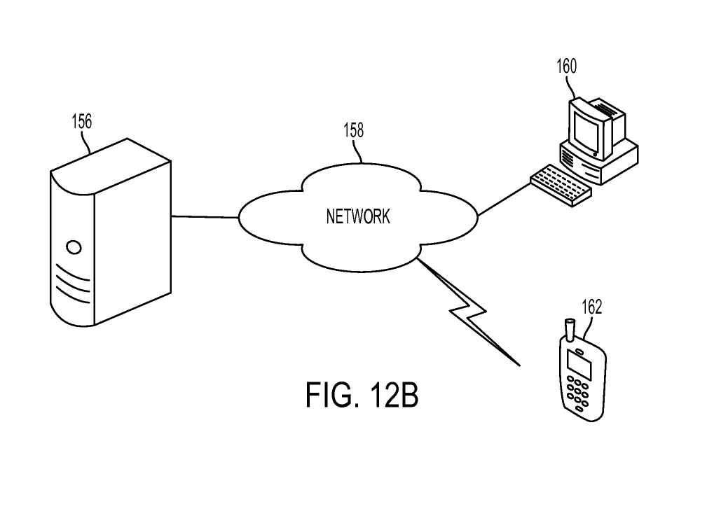

Referring to FIG. 12A, in its most basic configuration, computing device 144 typically includes at least one processing unit 150 and memory 146. Depending on the exact configuration and type of computing device, memory 146 can be volatile (such as RAM), non-volatile (such as ROM, flash memory, etc.) or some combination of the two.

Additionally, device 144 may also have other features and/or functionality. For example, the device could also include additional removable and/or non-removable storage including, but not limited to, magnetic or optical disks or tape, as well as writable electrical storage media. Such additional storage is the figure by removable storage 152 and non-removable storage 148. Computer storage media includes volatile and nonvolatile, removable and non-removable media implemented in any method or technology for storage of information such as computer readable instructions, data structures, program modules or other data. The memory, the removable storage and the non-removable storage are all examples of computer storage media. Computer storage media includes, but is not limited to, RAM, ROM, EEPROM, flash memory or other memory technology CDROM, digital versatile disks (DVD) or other optical storage, magnetic cassettes, magnetic tape, magnetic disk storage or other magnetic storage devices, or any other medium which can be used to store the desired information and which can accessed by the device. Any such computer storage media may be part of, or used in conjunction with, the device.

The device may also contain one or more communications connections 154 that allow the device to communicate with other devices (e.g. other computing devices). The communications connections carry information in a communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode, execute, or process information in the signal. By way of example, and not limitation, communication medium includes wired media such as a wired network or direct-wired connection, and wireless media such as radio, RF, infrared and other wireless media. As discussed above, the term computer readable media as used herein includes both storage media and communication media.

In addition to a stand-alone computing machine, embodiments of the invention can also be implemented on a network system comprising a plurality of computing devices that are in communication with a networking means, such as a network with an infrastructure or an ad hoc network. The network connection can be wired connections or wireless connections. As a way of example, FIG. 12B illustrates a network system in which embodiments of the invention can be implemented. In this example, the network system comprises computer 156 (e.g. a network server), network connection means 158 (e.g. wired and/or wireless connections), computer terminal 160, and PDA (e.g. a smart-phone) 162 (or other handheld or portable device, such as a cell phone, laptop computer, tablet computer, GPS receiver, mp3 player, handheld video player, pocket projector, etc. or handheld devices (or non portable devices) with combinations of such features). In an embodiment, it should be appreciated that the module listed as 156 may be a sequencer sample device or system. Any of the components shown or discussed with FIG. 9B may be multiple in number. The embodiments of the invention can be implemented in anyone of the devices of the system. For example, execution of the instructions or other desired processing can be performed on the same computing device that is anyone of 156, 160, and 162. Alternatively, an embodiment of the invention can be performed on different computing devices of the network system. For example, certain desired or required processing or execution can be performed on one of the computing devices of the network (e.g. server 156 and/or sequencer sample device), whereas other processing and execution of the instruction can be performed at another computing device (e.g. terminal 160) of the network system, or vice versa. In fact, certain processing or execution can be performed at one computing device (e.g. server 156 and/or sample device); and the other processing or execution of the instructions can be performed at different computing devices that may or may not be networked. For example, the certain processing can be performed at terminal 160, while the other processing or instructions are passed to device 162 where the instructions are executed. This scenario may be of particular value especially when the PDA 162 device, for example, accesses to the network through computer terminal 160 (or an access point in an ad hoc network). For another example, software to be protected can be executed, encoded or processed with one or more embodiments of the invention. The processed, encoded or executed software can then be distributed to customers. The distribution can be in a form of storage media (e.g. disk) or electronic copy.

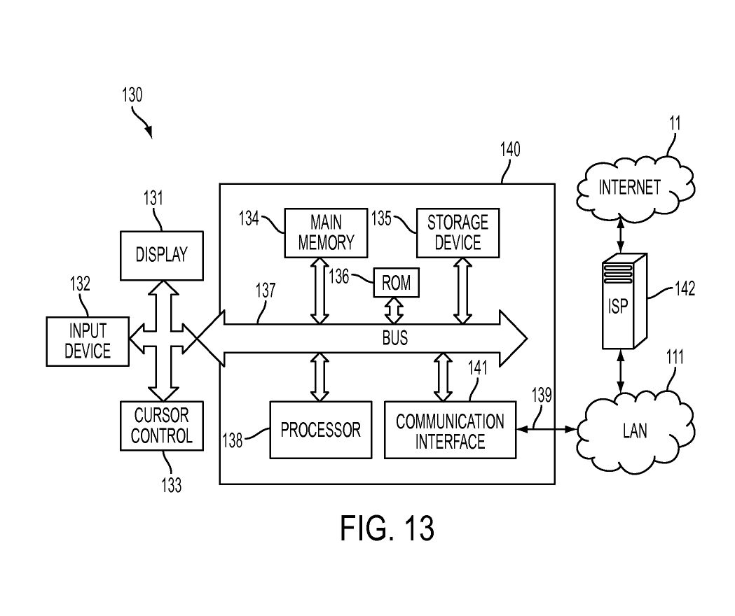

FIG. 13 is a block diagram that illustrates a system 130 including a computer system 140 and the associated Internet 11 connection upon which an embodiment may be implemented. Such configuration is typically used for computers (hosts) connected to the Internet 11 and executing a server or a client (or a combination) software. A source computer such as laptop, an ultimate destination computer and relay servers, for example, as well as any computer or processor described herein, may use the computer system configuration and the Internet connection shown in FIG. 13. The system 140 may be used as a portable electronic device such as a notebook/laptop computer, a media player (e.g., MP3 based or video player), a cellular phone, a Personal Digital Assistant (PDA), a sample device, an image processing device (e.g., a digital camera or video recorder), and/or any other handheld computing devices, or a combination of any of these devices. Note that while FIG. 13 illustrates various components of a computer system, it is not intended to represent any particular architecture or manner of interconnecting the components; as such details are not germane to the present invention. It will also be appreciated that network computers, handheld computers, cell phones and other data processing systems which have fewer components or perhaps more components may also be used. The computer system of FIG. 10 may, for example, be an Apple Macintosh computer or Power Book, or an IBM compatible PC. Computer system 140 includes a bus 137, an interconnect, or other communication mechanism for communicating information, and a processor 138, commonly in the form of an integrated circuit, coupled with bus 137 for processing information and for executing the computer executable instructions. Computer system 140 also includes a main memory 134, such as a Random Access Memory (RAM) or other dynamic storage device, coupled to bus 137 for storing information and instructions to be executed by processor 138.

Main memory 134 also may be used for storing temporary variables or other intermediate information during execution of instructions to be executed by processor 138. Computer system 140 further includes a Read Only Memory (ROM) 136 (or other non-volatile memory) or other static storage device coupled to bus 137 for storing static information and instructions for processor 138. A storage device 135, such as a magnetic disk or optical disk, a hard disk drive for reading from and writing to a hard disk, a magnetic disk drive for reading from and writing to a magnetic disk, and/or an optical disk drive (such as DVD) for reading from and writing to a removable optical disk, is coupled to bus 137 for storing information and instructions. The hard disk drive, magnetic disk drive, and optical disk drive may be connected to the system bus by a hard disk drive interface, a magnetic disk drive interface, and an optical disk drive interface, respectively. The drives and their associated computer-readable media provide non-volatile storage of computer readable instructions, data structures, program modules and other data for the general purpose computing devices. Typically computer system 140 includes an Operating System (OS) stored in a non-volatile storage for managing the computer resources and provides the applications and programs with an access to the computer resources and interfaces. An operating system commonly processes system data and user input, and responds by allocating and managing tasks and internal system resources, such as controlling and allocating memory, prioritizing system requests, controlling input and output devices, facilitating networking and managing files. Non-limiting examples of operating systems are Microsoft Windows, Mac OS X, and Linux.

The term “processor” is meant to include any integrated circuit or other electronic device (or collection of devices) capable of performing an operation on at least one instruction including, without limitation, Reduced Instruction Set Core (RISC) processors, CISC microprocessors, Microcontroller Units (MCUs), CISC-based Central Processing Units (CPUs), and Digital Signal Processors (DSPs). The hardware of such devices may be integrated onto a single substrate (e.g., silicon “die”), or distributed among two or more substrates. Furthermore, various functional aspects of the processor may be implemented solely as software or firmware associated with the processor.

Computer system 140 may be coupled via bus 137 to a display 131, such as a Cathode Ray Tube (CRT), a Liquid Crystal Display (LCD), a flat screen monitor, a touch screen monitor or similar means for displaying text and graphical data to a user. The display may be connected via a video adapter for supporting the display. The display allows a user to view, enter, and/or edit information that is relevant to the operation of the system. An input device 132, including alphanumeric and other keys, is coupled to bus 137 for communicating information and command selections to processor 138. Another type of user input device is cursor control 133, such as a mouse, a trackball, or cursor direction keys for communicating direction information and command selections to processor 138 and for controlling cursor movement on display 131. This input device typically has two degrees of freedom in two axes, a first axis (e.g., x) and a second axis (e.g., y), that allows the device to specify positions in a plane.

The computer system 140 may be used for implementing the methods and techniques described herein. According to one embodiment, those methods and techniques are performed by computer system 140 in response to processor 138 executing one or more sequences of one or more instructions contained in main memory 134. Such instructions may be read into main memory 134 from another computer-readable medium, such as storage device 135. Execution of the sequences of instructions contained in main memory 134 causes processor 138 to perform the process steps described herein. In alternative embodiments, hard-wired circuitry may be used in place of or in combination with software instructions to implement the arrangement. Thus, embodiments of the invention are not limited to any specific combination of hardware circuitry and software.

The term “computer-readable medium” (or “machine-readable medium”) as used herein is an extensible term that refers to any medium or any memory, that participates in providing instructions to a processor, (such as processor 138) for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, and transmission medium. Transmission media includes coaxial cables, copper wire and fiber optics, including the wires that comprise bus 137. Transmission media can also take the form of acoustic or light waves, such as those generated during radio-wave and infrared data communications, or other form of propagated signals (e.g., carrier waves, infrared signals, digital signals, etc.). Common forms of computer-readable media include, for example, a floppy disk, a flexible disk, hard disk, magnetic tape, or any other magnetic medium, a CD-ROM, any other optical medium, punch-cards, paper-tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to processor 138 for execution. For example, the instructions may initially be carried on a magnetic disk of a remote computer. The remote computer can load the instructions into its dynamic memory and send the instructions over a telephone line using a modem. A modem local to computer system 140 can receive the data on the telephone line and use an infra-red transmitter to convert the data to an infra-red signal. An infra-red detector can receive the data carried in the infra-red signal and appropriate circuitry can place the data on bus 137. Bus 137 carries the data to main memory 134, from which processor 138 retrieves and executes the instructions. The instructions received by main memory 134 may optionally be stored on storage device 135 either before or after execution by processor 138.

Computer system 140 also includes a communication interface 141 coupled to bus 137. Communication interface 141 provides a two-way data communication coupling to a network link 139 that is connected to a local network 111. For example, communication interface 141 may be an Integrated Services Digital Network (ISDN) card or a modem to provide a data communication connection to a corresponding type of telephone line. As another non-limiting example, communication interface 141 may be a local area network (LAN) card to provide a data communication connection to a compatible LAN. For example, Ethernet based connection based on IEEE802.3 standard may be used such as 10/100 BaseT, 1000 BaseT (gigabit Ethernet), 10 gigabit Ethernet (10 GE or 10 GbE or 10 GigE per IEEE Std 802.3ae-2002 as standard), 40 Gigabit Ethernet (40 GbE), or 100 Gigabit Ethernet (100 GbE as per Ethernet standard IEEE P802.3ba), as described in Cisco Systems, Inc. Publication number 1-587005-001-3 (June 1999), “Internetworking Technologies Handbook”, Chapter 7: “Ethernet Technologies”, pages 7-1 to 7-38, which is incorporated in its entirety for all purposes as if fully set forth herein. In such a case, the communication interface 141 typically include a LAN transceiver or a modem, such as Standard Microsystems Corporation (SMSC) LAN91C111 10/100 Ethernet transceiver described in the Standard Microsystems Corporation (SMSC) data-sheet “LAN91C111 10/100 Non-PCI Ethernet Single Chip MAC+PHY” Data-Sheet, Rev. 15 (Feb. 20, 2004), which is incorporated in its entirety for all purposes as if fully set forth herein.

Wireless links may also be implemented. In any such implementation, communication interface 141 sends and receives electrical, electromagnetic or optical signals that carry digital data streams representing various types of information.

Network link 139 typically provides data communication through one or more networks to other data devices. For example, network link 139 may provide a connection through local network 111 to a host computer or to data equipment operated by an Internet Service Provider (ISP) 142. ISP 142 in turn provides data communication services through the world wide packet data communication network Internet 11. Local network 111 and Internet 11 both use electrical, electromagnetic or optical signals that carry digital data streams. Also, satellite and network satellite communication and modules may be implemented. The signals through the various networks and the signals on the network link 139 and through the communication interface 141, which carry the digital data to and from computer system 140, are exemplary forms of carrier waves transporting the information.

A received code may be executed by processor 138 as it is received, and/or stored in storage device 135, or other non-volatile storage for later execution. In this manner, computer system 140 may obtain application code in the form of a carrier wave.

The concept of rapid classification of DNA for applications in various clinical, agricultural, environmental and military/forensic scenarios are disclosed herein, and may be implemented and utilized with the related processors, networks, computer systems, internet, and components and functions according to the schemes disclosed herein.

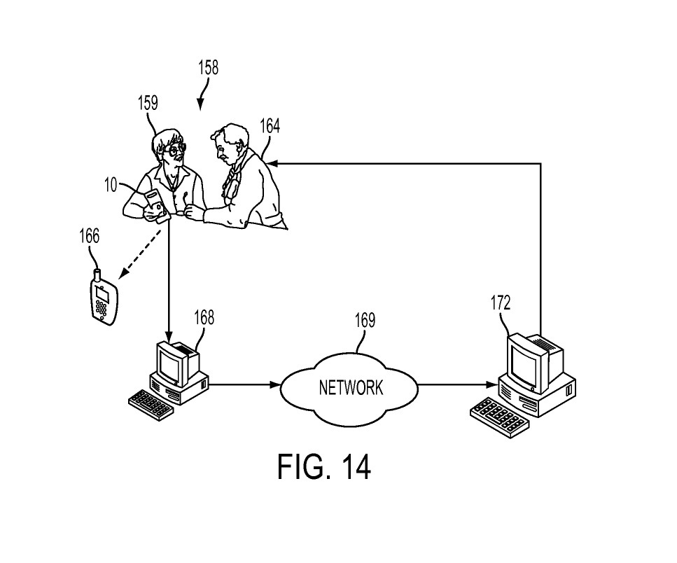

FIG. 14 illustrates a system in which one or more embodiments (or portions of an embodiment) of the invention can be implemented using a network, or portions of a network or computers. FIG. 14 diagrammatically illustrates an exemplary system in which examples of the invention can be implemented. In an embodiment the sequence sample device may be implemented by the subject (or patient) at home or other desired location. However, in an alternative embodiment it may be implemented in a clinic setting or operator-assistant setting. For instance, referring to FIG. 14, a clinic setup 158 provides a place for doctors (e.g. 164) or clinician/assistant to diagnose patients (e.g. 159) utilizing the rapid classification of DNA of the present invention, for example. A sequencer sample device 10 can be used to obtain information (such as nucleic acid sequencing information or data, protein sequencing information or data, or any other data or information as desired, needed or required depending on the type of information sampling device being utilized) from the sample or subject (patient). It should be appreciated that while only a sequencer sample device 10 is shown in the figure, the system of the invention and any component thereof may be used in the manner depicted by FIG. 11, for example. The system or component thereof may be affixed to or disposed within the sample or subject or in communication with the sample or subject as desired or required. For example, the system or combination of components thereof-including a sequencer sample device 10, or any other device or component-may be in contact or affixed to the sample or subject (patient) through mechanical means, as well as may be in communication through wired or wireless connections. Such sampling (or data/information gathering) may take place over a short term or long term, as well as any combination thereof. The sequencer sampling device outputs can be used by a variety of users (doctor, clinician, engineer, soldier, scientist, assistant, various technicians, etc.) for appropriate actions and applications. The sequencer sample device output can be delivered to the computer terminal 168 for processing and/or instant or future analyses in accordance to methods and techniques associated with an embodiment of the present invention. The sequencer sample device or system may be, for example, a nucleic acid sequencing device/system or protein sequencing device/system. The sequencer sample device/system may generate sequencing data or information using known techniques or other future available techniques. The delivery can be through cable or wireless or any other suitable medium. The sequencer sample device output from the general sample (substance or material) or subject (patient) can also be delivered to a portable device, such as PDA 166, or other available portable processors and systems for processing and performing the methods and techniques associated with an embodiment of the present invention. The information and data from the sequencer sample device can be delivered to remote centers or locations 172 for processing and/or analyzing according to an aspect of an embodiment of the present invention methods and techniques—such as for providing rapid classification of DNA. Such delivery can be accomplished in many ways, such as network connection 170, which can be wired or wireless. For example, it should be appreciated that the rapid classification approach of an embodiment of the present invention may occur locally in a device (e.g., processor) in the field or the data may be transmitted to at a remote location, such as to a classification server or the like. Any of the devices, modules, or systems may be portable or stationary, or any combination thereof. Any of the devices, modules, or systems may be interconnected with one another in any order or combination other than as specifically illustrated.

It should be appreciated that any of the components or modules referred to with regards to any of the present invention embodiments discussed herein, may be integrally or separately formed with one another. Further, redundant functions or structures of the components or modules may be implemented.

Examples of the invention can also be implemented in a standalone computing device associated with the target sample device. An exemplary computing device in which examples of the invention can be implemented is schematically illustrated in, but not limited thereto, FIGS. 1-3, and 10-13, for example.

### EXAMPLES

Practice of an aspect of an embodiment (or embodiments) of the invention will be still more fully understood from the following example, which are presented herein for illustration only and should not be construed as limiting the invention in any way.

### Example 1

A method for identifying a species, subspecies, and/or strain of an unknown sample, the method comprising: constructing distinct k-mer profiles from genomes of known species, sub-species, and strains; cataloging at least some of the constructed k-mer profiles; training the cataloged k-mer profiles to distinguish from species, subspecies, and/or strain in the catalog versus species subspecies, and/or strain, respectively, that are not in the catalog; receiving genome sequenced information from the unknown sample; and identifying, based on the trained catalog, the type or types of species, subspecies or strain contained within the unknown sample.

### Example 2

The method of example 1, wherein the constructing k-mer profiles comprises a probabilistic data structure.

### Example 3

The method of example 2, wherein the probabilistic data structure comprises one or more of any combination of the following: set of Bloom Filters, CountMin Sketch, Bitstate Hashing, and Hash Compaction.

### Example 4

The method of example 1, wherein the catalog is tailored for a particular application.

### Example 5

The method of example 4, wherein the particular application comprises at least one or more of any combination of the following: prediction of species of interest, prediction of a specific substrain of interest, detection of contaminated agriculture products, detection of contaminated water, detection of genetically-modified crops, exposure to biowarfare agents, detecting monitoring and tracking infection outbreaks, and disease prediction based on DNA circulating in blood or other tissue.

### Example 6

The method of example 1, wherein the training comprises a supervised learning algorithm.

### Example 7

The method of example 6, wherein the supervised learning algorithm comprises one or more of: machine learning or probabilistic selection.

### Example 8

The method of example 7, wherein the machine learning comprises one or more of any combination of the following: Naï ve Bayes Classifier, Neural Networks, Decision Trees, Generalized Linear Models, Nearest Neighbors, Support Vector Machines, or “ensemble” methods.

### Example 9

The method of example 1, wherein the training is accomplished through simulation.

### Example 10

The method of example 1, further comprising: providing the identified species, subspecies and/or strain to an output device.

### Example 11

The method of example 10, wherein the output device includes storage, memory, network, or a display (or other suitable module as desired or required).

### Example 12

The method of example 1, further comprising: sequencing information from the unknown sample to provide the sequenced information.

### Example 13

The method of example 12, wherein the sequencing information is obtained using a sequencing device.

### Example 14

A method of providing a trained catalog for the purpose of identifying a species, subspecies, or strain of an unknown sample, the method of creating the trained catalog comprising: constructing distinct k-mer profiles from genomes of known species, sub-species, and strains; selecting at least some of the constructed k-mer profiles to provide an interim catalog; and training the selected k-mer profiles to distinguish from species subspecies, and/or strain in the interim catalog versus species, subspecies, and/or strain, respectively, that are not in the interim catalog to provide the trained catalog, wherein the trained catalog is configured, based on the trained selection, to allow the type or types of species, subspecies or strain to be identified from an unknown sample.

### Example 15

The method of example 14, wherein the constructing k-mer profiles comprises a probabilistic data structure.

### Example 16

The method of example 15, wherein the probabilistic data structure comprises one or more of any combination of the following: set of Bloom Filters, CountMin Sketch, Bitstate Hashing, and Hash Compaction.

### Example 17

The method of example 14, wherein the interim catalog is tailored for a particular application.

### Example 18

The method of example 17, wherein the particular application comprises at least one or more of any combination of the following: prediction of species of interest, prediction of a specific substrain of interest, detection of contaminated agriculture products, detection of contaminated water, detection of genetically-modified crops, exposure to biowarfare agents, detecting monitoring and tracking infection outbreaks, and disease prediction based on DNA circulating in blood or other tissue.

### Example 19

The method of example 14, wherein the training comprises a supervised learning algorithm.

### Example 20

The method of example 19, wherein the supervised learning algorithm comprises one or more of: machine learning or probabilistic selection.

### Example 21

The method of example 20, wherein the machine learning comprises one or more of any combination of the following: Naï ve Bayes Classifier, Neural Networks, Decision Trees, Generalized Linear Models, Nearest Neighbors, Support Vector Machines, or “ensemble” methods.

### Example 22

The method of example 14, wherein the training is accomplished through simulation.

### Example 23

The method of example 14, further comprising: providing the trained catalog to an output device.

### Example 24

The method of example 23, wherein the output device includes storage, memory, network, or a display (or other suitable module as desired or required).

### Example 25

A method for identifying a species, subspecies, or strain of an unknown sample, the method comprising: inputting genome sequenced information from the unknown sample, and identifying the type or types of species, subspecies or strain contained within the unknown sample using a trained catalog. Wherein the trained catalog comprises: a construction of distinct k-mer profiles from genomes of known species, sub-species, and strains; and a collection of at least some of the constructed k-mer profiles, wherein the collection have been trained to distinguish from species, subspecies, and/or strain in the collection versus species, subspecies, and/or strain that are not in the collection.

### Example 26

The method of example 25, wherein the collection is tailored for a particular application.

### Example 27

The method of example 26, wherein the particular application comprises at least one or more of any combination of the following: prediction of species of interest, prediction of a specific substrain of interest, detection of contaminated agriculture products, detection of contaminated water, detection of genetically-modified crops, exposure to biowarfare agents, detecting monitoring and tracking infection outbreaks, and disease prediction based on DNA circulating in blood or other tissue.

### Example 28

The method of example 25, further comprising: providing the identified type or types of species, subspecies or strain to an output device.

### Example 29

The method of example 28, wherein the output device includes storage, memory, network, or a display (or other suitable module as desired or required).

### Example 30

A method for identifying a species, subspecies, or strain of an unknown sample, the method comprising: receiving genome sequenced information from the unknown sample, and identifying the type or types of species, subspecies or strain contained within the unknown sample using a trained catalog. Wherein the trained catalog comprises: a construction of distinct k-mer profiles from genomes of known species, sub-species, and strains; and a collection of at least some of the constructed k-mer profiles, wherein the collection have been trained to distinguish from species subspecies, and/or strain in the collection versus species subspecies, and/or strain that are not in the collection.

### Example 31

The method of example 30, wherein the collection is tailored for a particular application.

### Example 32

The method of example 31, wherein the particular application comprises at least one or more of any combination of the following: prediction of species of interest, prediction of a specific substrain of interest, detection of contaminated agriculture products, detection of contaminated water, detection of genetically-modified crops, exposure to biowarfare agents, detecting monitoring and tracking infection outbreaks, and disease prediction based on DNA circulating in blood or other tissue.

### Example 33

The method of example 30, further comprising: providing the identified type or types of species, subspecies or strain to an output device.

### Example 34

The method of example 33, wherein the output device includes storage, memory, network, or a display (or other suitable module as desired or required).

### Example 35

A system for identifying a species, subspecies, and/or strain of an unknown sample, the system comprising: a circuit configured for constructing distinct k-mer profiles from genomes of known species, sub-species, and strains; a circuit configured for cataloging at least some of the constructed k-mer profiles; a circuit configured for training the cataloged k-mer profiles to distinguish from species, subspecies, and/or strain in the catalog versus species subspecies, and/or strain, respectively, that are not in the catalog; a circuit configured for receiving genome sequenced information from the unknown sample; and a circuit configured for identifying, based on the trained catalog, the type or types of species, subspecies or strain contained within the unknown sample.

### Example 36

The system of example 35, wherein the constructing k-mer profiles comprises a probabilistic data structure.

### Example 37

The system of example 36, wherein the probabilistic data structure comprises one or more of any combination of the following: set of Bloom Filters, CountMin Sketch, Bitstate Hashing, and Hash Compaction.

### Example 38

The system of example 35, wherein the catalog is tailored for a particular application.

### Example 39

The system of example 38, wherein the particular application comprises at least one or more of any combination of the following: prediction of species of interest, prediction of a specific substrain of interest, detection of contaminatedagriculture products, detection of contaminated water, detection of genetically-modified crops, exposure to biowarfare agents, detecting monitoring and tracking infection outbreaks, and disease prediction based on DNA circulating in blood or other tissue.

### Example 40

The system of example 35, wherein the training comprises a supervised learning algorithm.

### Example 41

The system of example 40, wherein the supervised learning algorithm comprises one or more of: machine learning, probabilistic selection.

### Example 42

The system of example 41, wherein the machine learning comprises one or more of any combination of the following: Naï ve Bayes Classifier, Neural Networks, Decision Trees, Generalized Linear Models, Nearest Neighbors, Support Vector Machines, or “ensemble” methods.

### Example 43

The system of example 35, wherein the training is accomplished through simulation.

### Example 44

The system of example 35, further comprising: an output device configured for receiving the identified species, subspecies and/or strain to an output device.

### Example 45

The system of example 44, wherein the output device includes storage, memory, network, or a display (or other suitable module as desired or required).

### Example 46

The system of example 35, further comprising: a genome sequencer device configured sequencing information from the unknown sample to provide the sequenced information.

### Example 47

The system of example 46, wherein the sequencer device is stationary or portable, or a combination of stationary and portable.

### Example 48

A system of providing a trained catalog for the purpose of identifying a species, subspecies, or strain of an unknown sample, the system of creating the trained catalog comprising: a circuit configured for constructing distinct k-mer profiles from genomes of known species, sub-species, and strains; a circuit configured for selecting at least some of the constructed k-mer profiles to provide an interim catalog; and a circuit configured for training the selected k-mer profiles to distinguish from species subspecies, and/or strain in the interim catalog versus species, subspecies, and/or strain, respectively, that are not in the interim catalog to provide the trained catalog, wherein the trained catalog is configured, based on the trained selection, to allow the type or types of species, subspecies or strain to be identified from an unknown sample.

### Example 49

The system of example 48, wherein the constructing k-mer profiles comprises a probabilistic data structure.

### Example 50

The system of example 49, wherein the probabilistic data structure comprises one or more of any combination of the following: set of Bloom Filters, CountMin Sketch, Bitstate Hashing, and Hash Compaction.

### Example 51

The system of example 48, wherein the interim catalog is tailored for a particular application.

### Example 52

The system of example 51, wherein the particular application comprises at least one or more of any combination of the following: prediction of species of interest, prediction of a specific substrain of interest, detection of contaminated agriculture products, detection of contaminated water, detection of genetically-modified crops, exposure to biowarfare agents, detecting monitoring and tracking infection outbreaks, and disease prediction based on DNA circulating in blood or other tissue.

### Example 53

The system of example 48, wherein the training comprises a supervised learning algorithm.

### Example 54

The system of example 53, wherein the supervised learning algorithm comprises one or more of: machine learning, probabilistic selection.

### Example 55

The system of example 54, wherein the machine learning comprises one or more of any combination of the following: Naï ve Bayes Classifier, Neural Networks, Decision Trees, Generalized Linear Models, Nearest Neighbors, Support Vector Machines, or “ensemble” methods.

### Example 56

The system of example 48, wherein the training is accomplished through simulation.

### Example 57

The system of example 48, further comprising: a circuit configured communicating the trained catalog to an output device.

### Example 58

The system of example 57, wherein the output device includes storage, memory, network, or a display (or other suitable module as desired or required).

### Example 59

A system for identifying a species, subspecies, or strain of an unknown sample, the system comprising: a circuit configured for inputting genome sequenced information from the unknown sample, and a circuit configured for identifying the type or types of species, subspecies or strain contained within the unknown sample using a trained catalog. Wherein the trained catalog comprises: a construction of distinct k-mer profiles from genomes of known species, sub-species, and strains; and a collection of at least some of the constructed k-mer profiles, wherein the collection have been trained to distinguish from species, subspecies, and/or strain in the collection versus species, subspecies, and/or strain that are not in the collection.

### Example 60

The system of example 59, wherein the collection is tailored for a particular application.

### Example 61

The system of example 60, wherein the particular application comprises at least one or more of any combination of the following: prediction of species of interest, prediction of a specific substrain of interest, detection of contaminatedagriculture products, detection of contaminated water, detection of genetically-modified crops, exposure to biowarfare agents, detecting monitoring and tracking infection outbreaks, and disease prediction based on DNA circulating in blood or other tissue.

### Example 62

The system of example 59, further comprising: an output device configured for receiving the identified species, subspecies and/or strain.

### Example 63

The system of example 62, wherein the output device includes storage, memory, network, or a display (or other suitable module as desired or required).

### Example 64

A system for identifying a species, subspecies, or strain of an unknown sample, the system comprising: a circuit configured for receiving genome sequenced information from the unknown sample, and a circuit configured for identifying the type or types of species, subspecies or strain contained within the unknown sample using a trained catalog. Wherein the trained catalog comprises: a construction of distinct k-mer profiles from genomes of known species, sub-species, and strains; and a collection of at least some of the constructed k-mer profiles, wherein the collection have been trained to distinguish from species subspecies, and/or strain in the collection versus species subspecies, and/or strain that are not in the collection.

### Example 65

The system of example 64, wherein the collection is tailored for a particular application.

### Example 66

The system of example 65, wherein the particular application comprises at least one or more of any combination of the following: prediction of species of interest, prediction of a specific substrain of interest, detection of contaminatedagriculture products, detection of contaminated water, detection of genetically-modified crops, exposure to biowarfare agents, detecting monitoring and tracking infection outbreaks, and disease prediction based on DNA circulating in blood or other tissue.

### Example 67

The system of example 64, further comprising: an output device configured for receiving the identified species, subspecies and/or strain.

### Example 68

The system of example 67, wherein the output device includes storage, memory, network, or a display (or other suitable module as desired or required).

### Example 69

The system of example 35, further comprising one or more of any combination of the following biological related devices: needle, swab, pipette, substrate, microchannel, conduit, channel, lab-on-chip device, or needle, wherein the biological related devices being configured for obtaining or accommodating the sample.

### Example 70

The system of example 59, further comprising one or more of any combination of the following biological related devices: needle, swab, pipette, substrate, microchannel, conduit, channel, lab-on-chip device, or needle, wherein the biological related devices being configured for obtaining or accommodating the sample.

### Example 71

A non-transitory machine-readable medium, including instructions, which when executed by a machine, cause the machine to: construct distinct k-mer profiles from genomes of known species, sub-species, and strains; catalog at least some of the constructed k-mer profiles; train the cataloged k-mer profiles to distinguish from species, subspecies, and/or strain in the catalog versus species subspecies, and/or strain, respectively, that are not in the catalog; receive genome sequenced information from the unknown sample, and identify, based on the trained catalog, the type or types of species, subspecies or strain contained within the unknown sample.

### Example 72

A non-transitory machine-readable medium, including instructions, which when executed by a machine, cause the machine to: construct distinct k-mer profiles from genomes of known species, sub-species, and strains; select at least some of the constructed k-mer profiles to provide an interim catalog; and train the selected k-mer profiles to distinguish from species subspecies, and/or strain in the interim catalog versus species, subspecies, and/or strain, respectively, that are not in the interim catalog to provide the trained catalog, wherein the trained catalog is configured, based on the trained selection, to allow the type or types of species, subspecies or strain to be identified from an unknown sample.

### Example 73

A non-transitory machine-readable medium, including instructions, which when executed by a machine, cause the machine to: input genome sequenced information from the unknown sample, and identify the type or types of species, subspecies or strain contained within the unknown sample using a trained catalog. Wherein the trained catalog comprises: a construction of distinct k-mer profiles from genomes of known species, sub-species, and strains; and a collection of at least some of the constructed k-mer profiles, wherein the collection have been trained to distinguish from species, subspecies, and/or strain in the collection versus species, subspecies, and/or strain that are not in the collection.

### Example 74

A non-transitory machine-readable medium, including instructions, which when executed by a machine, cause the machine to: receive genome sequenced information from the unknown sample, and identify the type or types of species, subspecies or strain contained within the unknown sample using a trained catalog. Wherein the trained catalog comprises: a construction of distinct k-mer profiles from genomes of known species, sub-species, and strains; and a collection of at least some of the constructed k-mer profiles, wherein the collection have been trained to distinguish from species subspecies, and/or strain in the collection versus species subspecies, and/or strain that are not in the collection.

### Example 75

The method of using any of the devices, system, or its components provided in any one or more of examples 35-74.

### Example 76

The method of manufacturing any of the devices, systems, or its components provided in any one or more of examples 35-74.

It should be appreciated that the subject matter of one or more of any combination of the methods disclosed in examples 1-34 may be implemented as desired, required, or needed.

It should be appreciated that the subject matter of one or more of any combination of the systems disclosed in examples 35-70 may be implemented as desired, required, or needed.

It should be appreciated that the subject matter of one or more of any combination of the machine readable medium disclosed in examples 71-74 may be implemented as desired, required, or needed.

It should be appreciated that the machine readable medium disclosed in examples 71-74 may be configured to execute the subject matter of one or more of any combination of the methods disclosed in examples 1-34 as desired, required, or needed.

### REFERENCES

The following patents, applications and publications as listed below and throughout this document are hereby incorporated by reference in their entirety herein. The devices, systems, compositions, computer readable medium, and methods of various embodiments of the invention disclosed herein may utilize aspects disclosed in the following references, applications, publications and patents and which are hereby incorporated by reference herein in their entirety (and which are not admitted to be prior art with respect to the present invention by inclusion in this section):

[1] Bloom, Burton H. (1970), “Space/time trade-offs in hash coding with allowable errors”, Communications of the ACM 13 (7): 422-426, doi:10.1145/362686.362692.

[2] Henrik Stranneheim, Max Kaller, Tobias Allander, Bjorn Andersson, Lars Arvestad, and Joakim Lundeberg. Classification of DNA sequences using Bloom filters. Bioinformatics (2010) 26(13): 1595-1600 first published online May 13, 2010

[3] Sci Transl Med. 2012 Aug. 22; 4(148):148ra116. doi: 10.1126/scitranslmed.3004129. Tracking a hospital outbreak of carbapenem-resistant Klebsiella pneumoniae with whole-genome sequencing. Snitkin E S, Zelazny A M, Thomas P J, Stock F; NISC Comparative Sequencing Program Group, Henderson D K, Palmore T N, Segre J A.

[4] U.S. Publication No. 2011/0231446 A1 to Buhler et al., Sep. 22, 2011, entitled “Method and Apparatus for Performing Similarity Searching.”

[5] Jeremy Daniel Buhler, Roger Dean Chamberlain, Mark Allen Franklin, Kwame Gyang, Arpith Chacko Jacob, Praveen Krishnamurthy, and Joseph Marion Lancaster. Method and apparatus for performing biosequence similarity searching. U.S. Patent Application Publication No. 2007/0067108, Mar. 22, 2007.

[6] U.S. Pat. No. 7,917,299 B2, Buhler, et al., “Method and Apparatus for Performing Similarity Searching on a Data Stream with Respect to a Query String”, Mar. 19, 2011.

[7] U.S. Pat. No. 6,147,890, Kawana, et al., “FPGA with Embedded Content-Addressable Memory”, Nov. 14, 2000.

[8] U.S. Pat. No. 6,272,616 B1, Fernando, et al., “Method and Apparatus for Executing Multiple Instruction Streams in a Digital Processor with Multiple Data Paths”, Aug. 7, 2001.

[9] U.S. Patent Application Publication No. 2012/0130922 A1, Indeck, et al., “Method and Apparatus for Processing Financial Information at Hardware Speeds Using FPGA Devices”, May 24, 2012.

[10] U.S. Patent Application Publication No. 2012/0215801 A1, Indeck, et al., “Method and Apparatus for Adjustable Data Matching”, Aug. 23, 2012.

[11] European Patent Application No. EP 0 989 754 A2, Toguri, et al., “Information Processing Apparatus and Method, Information Recording Apparatus and Method, Recording Medium, and Distribution Medium”, Sep. 23, 1999.

[12] Wood, D.E., et al., “Kraken: ultrafast metagenomic sequence classification using exact alignments”, Genome Biology 2014, 15:R46 http://genomebiology.com/2014/15/3/R46

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the disclosure, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

We claim:

1. A method for identifying a species, subspecies, and/or strain of an unknown sample, said method comprising:
constructing distinct k-mer profiles from genomes of known species, sub-species, and strains;
cataloging at least some of said constructed k-mer profiles;
training said cataloged k-mer profiles to distinguish from species, subspecies, and/or strain in said catalog versus species subspecies, and/or strain, respectively, that are not in said catalog;
receiving genome sequenced information from the unknown sample; and
identifying, based on said trained catalog, the type or types of species, subspecies or strain contained within said unknown sample.

2. The method of claim 1, wherein said constructing k-mer profiles comprises a probabilistic data structure.

3. The method of claim 2, wherein said probabilistic data structure comprises one or more of any combination of the following: set of Bloom Filters, CountMin Sketch, Bitstate Hashing, and Hash Compaction.

4. The method of claim 1, wherein said catalog is tailored for a particular application.

5. The method of claim 4, wherein said particular application comprises at least one or more of any combination of the following: prediction of species of interest, prediction of a specific substrain of interest, detection of contaminated agriculture products, detection of contaminated water, detection of genetically-modified crops, exposure to biowarfare agents, detecting monitoring and tracking infection outbreaks, and disease prediction based on DNA circulating in blood or other tissue.

6. The method of claim 1, wherein said training comprises a supervised learning algorithm.

7. The method of claim 6, wherein said supervised learning algorithm comprises one or more of: machine learning or probabilistic selection.

8. The method of claim 7, wherein said machine learning comprises one or more of any combination of the following: Naï ve Bayes Classifier, Neural Networks, Decision Trees, Generalized Linear Models, Nearest Neighbors, Support Vector Machines, or “ensemble” methods.

9. The method of claim 1, wherein said training is accomplished through simulation.

10. The method of claim 1, further comprising:
providing said identified species, subspecies and/or strain to an output device.

11. The method of claim 10, wherein said output device includes storage, memory, network, or a display.

12. The method of claim 1, further comprising:
sequencing information from the unknown sample to provide the sequenced information.

13. The method of claim 12, wherein said sequencing information is obtained using a sequencing device.

14. A method of providing a trained catalog for the purpose of identifying a species, subspecies, or strain of an unknown sample, said method of creating said trained catalog comprising:
constructing distinct k-mer profiles from genomes of known species, sub-species, and strains;
selecting at least some of said constructed k-mer profiles to provide an interim catalog; and
training said selected k-mer profiles to distinguish from species subspecies, and/or strain in said interim catalog versus species, subspecies, and/or strain, respectively, that are not in said interim catalog to provide said trained catalog, wherein said trained catalog is configured, based on said trained selection, to allow the type or types of species, subspecies or strain to be identified from an unknown sample.

15. The method of claim 14, wherein said constructing k-mer profiles comprises a probabilistic data structure.

16. The method of claim 15, wherein said probabilistic data structure comprises one or more of any combination of the following: set of Bloom Filters, CountMin Sketch, Bitstate Hashing, and Hash Compaction.

17. The method of claim 14, wherein said interim catalog is tailored for a particular application.

18. The method of claim 17, wherein said particular application comprises at least one or more of any combination of the following: prediction of species of interest, prediction of a specific substrain of interest, detection of contaminated agriculture products, detection of contaminated water, detection of genetically-modified crops, exposure to biowarfare agents, detecting monitoring and tracking infection outbreaks, and disease prediction based on DNA circulating in blood or other tissue.

19. The method of claim 14, wherein said training comprises a supervised learning algorithm.

20. The method of claim 19, wherein said supervised learning algorithm comprises one or more of: machine learning or probabilistic selection.

21. The method of claim 20, wherein said machine learning comprises one or more of any combination of the following: Naï ve Bayes Classifier, Neural Networks, Decision Trees, Generalized Linear Models, Nearest Neighbors, Support Vector Machines, or “ensemble” methods.

22. The method of claim 14, wherein said training is accomplished through simulation.

23. The method of claim 14, further comprising:
providing said trained catalog to an output device.

24. The method of claim 23, wherein said output device includes storage, memory, network, or a display.

25. A method for identifying a species, subspecies, or strain of an unknown sample, said method comprising:
inputting genome sequenced information from the unknown sample, and
identifying the type or types of species, subspecies or strain contained within said unknown sample using a trained catalog, wherein said trained catalog comprises:
a construction of distinct k-mer profiles from genomes of known species, sub-species, and strains; and
a collection of at least some of said constructed k-mer profiles, wherein said collection have been trained to distinguish from species, subspecies, and/or strain in said collection versus species, subspecies, and/or strain that are not in said collection.

26. The method of claim 25, wherein said collection is tailored for a particular application.

27. The method of claim 26, wherein said particular application comprises at least one or more of any combination of the following: prediction of species of interest, prediction of a specific substrain of interest, detection of contaminated agriculture products, detection of contaminated water, detection of genetically-modified crops, exposure to biowarfare agents, detecting monitoring and tracking infection outbreaks, and disease prediction based on DNA circulating in blood or other tissue.

28. The method of claim 25, further comprising:
providing said identified type or types of species, subspecies or strain to an output device.

29. The method of claim 28, wherein said output device includes storage, memory, network, or a display.

30. A method for identifying a species, subspecies, or strain of an unknown sample, said method comprising:
receiving genome sequenced information from the unknown sample, and
identifying the type or types of species, subspecies or strain contained within said unknown sample using a trained catalog, wherein said trained catalog comprises:
a construction of distinct k-mer profiles from genomes of known species, sub-species, and strains; and
a collection of at least some of said constructed k-mer profiles, wherein said collection have been trained to distinguish from species subspecies, and/or strain in said collection versus species subspecies, and/or strain that are not in said collection.

31. The method of claim 30, wherein said collection is tailored for a particular application.

32. The method of claim 31, wherein said particular application comprises at least one or more of any combination of the following: prediction of species of interest, prediction of a specific substrain of interest, detection of contaminated agriculture products, detection of contaminated water, detection of genetically-modified crops, exposure to biowarfare agents, detecting monitoring and tracking infection outbreaks, and disease prediction based on DNA circulating in blood or other tissue.

33. The method of claim 30, further comprising:
providing said identified type or types of species, subspecies or strain to an output device.

34. The method of claim 33, wherein said output device includes storage, memory, network, or a display.

35. A system for identifying a species, subspecies, and/or strain of an unknown sample, said system comprising:
a circuit configured for constructing distinct k-mer profiles from genomes of known species, sub-species, and strains;
a circuit configured for cataloging at least some of said constructed k-mer profiles;
a circuit configured for training said cataloged k-mer profiles to distinguish from species, subspecies, and/or strain in said catalog versus species subspecies, and/or strain, respectively, that are not in said catalog;
a circuit configured for receiving genome sequenced information from the unknown sample; and
a circuit configured for identifying, based on said trained catalog, the type or types of species, subspecies or strain contained within said unknown sample.

36. The system of claim 35, wherein said constructing k-mer profiles comprises a probabilistic data structure.

37. The system of claim 36, wherein said probabilistic data structure comprises one or more of any combination of the following: set of Bloom Filters, CountMin Sketch, Bitstate Hashing, and Hash Compaction.

38. The system of claim 35, wherein said catalog is tailored for a particular application.

39. The system of claim 38, wherein said particular application comprises at least one or more of any combination of the following: prediction of species of interest, prediction of a specific substrain of interest, detection of contaminatedagriculture products, detection of contaminated water, detection of genetically-modified crops, exposure to biowarfare agents, detecting monitoring and tracking infection outbreaks, and disease prediction based on DNA circulating in blood or other tissue.

40. The system of claim 35, wherein said training comprises a supervised learning algorithm.

41. The system of claim 40, wherein said supervised learning algorithm comprises one or more of: machine learning, probabilistic selection.

42. The system of claim 41, wherein said machine learning comprises one or more of any combination of the following: Naï ve Bayes Classifier, Neural Networks, Decision Trees, Generalized Linear Models, Nearest Neighbors, Support Vector Machines, or “ensemble” methods.

43. The system of claim 35, wherein said training is accomplished through simulation.

44. The system of claim 35, further comprising:
an output device configured for receiving said identified species, subspecies and/or strain to an output device.

45. The system of claim 44, wherein said output device includes storage, memory, network, or a display.

46. The system of claim 35, further comprising:
a genome sequencer device configured sequencing information from the unknown sample to provide the sequenced information.

47. The system of claim 46, wherein said sequencer device is stationary or portable, or a combination of stationary and portable.

48. A system of providing a trained catalog for the purpose of identifying a species, subspecies, or strain of an unknown sample, said system of creating said trained catalog comprising:
a circuit configured for constructing distinct k-mer profiles from genomes of known species, sub-species, and strains;
a circuit configured for selecting at least some of said constructed k-mer profiles to provide an interim catalog; and
a circuit configured for training said selected k-mer profiles to distinguish from species subspecies, and/or strain in said interim catalog versus species, subspecies, and/or strain, respectively, that are not in said interim catalog to provide said trained catalog, wherein said trained catalog is configured, based on said trained selection, to allow the type or types of species, subspecies or strain to be identified from an unknown sample.

49. The system of claim 48, wherein said constructing k-mer profiles comprises a probabilistic data structure.

50. The system of claim 49, wherein said probabilistic data structure comprises one or more of any combination of the following: set of Bloom Filters, CountMin Sketch, Bitstate Hashing, and Hash Compaction.

51. The system of claim 48, wherein said interim catalog is tailored for a particular application.

52. The system of claim 51, wherein said particular application comprises at least one or more of any combination of the following: prediction of species of interest, prediction of a specific substrain of interest, detection of contaminated agriculture products, detection of contaminated water, detection of genetically-modified crops, exposure to biowarfare agents, detecting monitoring and tracking infection outbreaks, and disease prediction based on DNA circulating in blood or other tissue.

53. The system of claim 48, wherein said training comprises a supervised learning algorithm.

54. The system of claim 53, wherein said supervised learning algorithm comprises one or more of: machine learning, probabilistic selection.

55. The system of claim 54, wherein said machine learning comprises one or more of any combination of the following: Naï ve Bayes Classifier, Neural Networks, Decision Trees, Generalized Linear Models, Nearest Neighbors, Support Vector Machines, or “ensemble” methods.

56. The system of claim 48, wherein said training is accomplished through simulation.

57. The system of claim 48, further comprising:
a circuit configured communicating said trained catalog to an output device.

58. The system of claim 57, wherein said output device includes storage, memory, network, or a display.

59. A system for identifying a species, subspecies, or strain of an unknown sample, said system comprising:
a circuit configured for inputting genome sequenced information from the unknown sample, and
a circuit configured for identifying the type or types of species, subspecies or strain contained within said unknown sample using a trained catalog, wherein said trained catalog comprises:
a construction of distinct k-mer profiles from genomes of known species, sub-species, and strains; and
a collection of at least some of said constructed k-mer profiles, wherein said collection have been trained to distinguish from species, subspecies, and/or strain in said collection versus species, subspecies, and/or strain that are not in said collection.

60. The system of claim 59, wherein said collection is tailored for a particular application.

61. The system of claim 60, wherein said particular application comprises at least one or more of any combination of the following: prediction of species of interest, prediction of a specific substrain of interest, detection of contaminatedagriculture products, detection of contaminated water, detection of genetically-modified crops, exposure to biowarfare agents, detecting monitoring and tracking infection outbreaks, and disease prediction based on DNA circulating in blood or other tissue.

62. The system of claim 59, further comprising:
an output device configured for receiving said identified species, subspecies and/or strain.

63. The system of claim 62, wherein said output device includes storage, memory, network, or a display.

64. A system for identifying a species, subspecies, or strain of an unknown sample, said system comprising:
a circuit configured for receiving genome sequenced information from the unknown sample, and
a circuit configured for identifying the type or types of species, subspecies or strain contained within said unknown sample using a trained catalog, wherein said trained catalog comprises:
a construction of distinct k-mer profiles from genomes of known species, sub-species, and strains; and
a collection of at least some of said constructed k-mer profiles, wherein said collection have been trained to distinguish from species subspecies, and/or strain in said collection versus species subspecies, and/or strain that are not in said collection.

65. The system of claim 64, wherein said collection is tailored for a particular application.

66. The system of claim 65, wherein said particular application comprises at least one or more of any combination of the following: prediction of species of interest, prediction of a specific substrain of interest, detection of contaminatedagriculture products, detection of contaminated water, detection of genetically-modified crops, exposure to biowarfare agents, detecting monitoring and tracking infection outbreaks, and disease prediction based on DNA circulating in blood or other tissue.

67. The system of claim 64, further comprising:
an output device configured for receiving said identified species, subspecies and/or strain.

68. The system of claim 67, wherein said output device includes storage, memory, network, or a display.

69. The system of claim 35, further comprising one or more of any combination of the following biological related devices: needle, swab, pipette, substrate, microchannel, conduit, channel, lab-on-chip device, or needle, wherein said biological related devices being configured for obtaining or accommodating the sample.

70. The system of claim 59, further comprising one or more of any combination of the following biological related devices: needle, swab, pipette, substrate, microchannel, conduit, channel, lab-on-chip device, or needle, wherein said biological related devices being configured for obtaining or accommodating the sample.

71. A non-transitory machine-readable medium, including instructions, which when executed by a machine, cause the machine to:
construct distinct k-mer profiles from genomes of known species, sub-species, and strains;
catalog at least some of said constructed k-mer profiles;
train said cataloged k-mer profiles to distinguish from species, subspecies, and/or strain in said catalog versus species subspecies, and/or strain, respectively, that are not in said catalog;
receive genome sequenced information from the unknown sample, and
identify, based on said trained catalog, the type or types of species, subspecies or strain contained within said unknown sample.

72. A non-transitory machine-readable medium, including instructions, which when executed by a machine, cause the machine to:
construct distinct k-mer profiles from genomes of known species, sub-species, and strains;
select at least some of said constructed k-mer profiles to provide an interim catalog; and
train said selected k-mer profiles to distinguish from species subspecies, and/or strain in said interim catalog versus species, subspecies, and/or strain, respectively, that are not in said interim catalog to provide said trained catalog, wherein said trained catalog is configured, based on said trained selection, to allow the type or types of species, subspecies or strain to be identified from an unknown sample.

73. A non-transitory machine-readable medium, including instructions, which when executed by a machine, cause the machine to:
input genome sequenced information from the unknown sample, and
identify the type or types of species, subspecies or strain contained within said unknown sample using a trained catalog, wherein said trained catalog comprises:
a construction of distinct k-mer profiles from genomes of known species, sub-species, and strains; and
a collection of at least some of said constructed k-mer profiles, wherein said collection have been trained to distinguish from species, subspecies, and/or strain in said collection versus species, subspecies, and/or strain that are not in said collection.

74. A non-transitory machine-readable medium, including instructions, which when executed by a machine, cause the machine to:
receive genome sequenced information from the unknown sample, and
identify the type or types of species, subspecies or strain contained within said unknown sample using a trained catalog, wherein said trained catalog comprises:
a construction of distinct k-mer profiles from genomes of known species, sub-species, and strains; and
a collection of at least some of said constructed k-mer profiles, wherein said collection have been trained to distinguish from species subspecies, and/or strain in said collection versus species subspecies, and/or strain that are not in said collection.
